(19) United States
(12) Patent Application Publication
(10) Pub. No.: US 2024/0330548 A1
(43) Pub. Date: Oct. 3, 2024

(54) DYNAMIC CONTROL OF CIRCUIT DESIGN EMULATION

(71) Applicant: Synopsys, Inc., Sunnyvale, CA (US)

(72) Inventors: Etienne LEPERCQ, Shrewsbury, MA (US); Mikhail BERSHTEYN, Forest Hills, NY (US); Marc-Andre DAIGNEAULT, Ashland, MA (US)

(21) Appl. No.: 18/127,376

(22) Filed: Mar. 28, 2023

(51) Int. Cl. G06F 30/3308

(52) U.S. Cl. CPC G06F 30/3308

(57) ABSTRACT

Emulating a circuit design includes receiving a circuit design. The circuit design is mapped onto integrated circuit (IC) devices. Further, the circuit design that is mapped onto the IC devices is instrumented by inserting a first change detection circuit and a first synchronization circuit. The first synchronization circuit is connected to the first change detection circuit and stops emulation on one of the IC devices based on an output of the first change detection circuit and completion of a first one or more emulation cycles. Further, the IC devices are provided for emulation.

### TECHNICAL FIELD

The present disclosure generally relates to an emulation system. In particular, the present disclosure relates to dynamically controlling the emulation process of a circuit design based on detected changes to signal voltages.

### BACKGROUND

Emulation of a circuit design verifies the functionality and performance of the circuit design. During the emulation process, the circuit design may be debugged, correcting errors within the circuit design. Emulation is performed by an emulation system (e.g., an emulator). The emulation system includes one or more programmable integrated circuit (IC) devices that are programmed according to the circuit design. The IC devices are field programmable gate arrays (FPGAs) or other types of programmable IC devices. Multiple IC devices are used to emulate a circuit design. Accordingly, timing paths may cross between the IC devices. The timing paths are associated with signals that are communicated between the IC devices. The timing paths may span between two or more IC devices. To ensure that the signals along the timing paths are able to propagate before the completion of the emulation process, the longest propagation time of all timing paths is determined. The run time performance of the emulation system corresponds to the longest propagation time.

### SUMMARY

In one example, a method includes receiving a circuit design. The circuit design is mapped onto integrated circuit (IC) devices. The method further includes instrumenting the circuit design mapped onto the IC devices by inserting a first change detection circuit and a first synchronization circuit. The first synchronization circuit is connected to the first change detection circuit and stops emulation on one of the IC devices based on an output of the first change detection circuit and completion of a first one or more emulation cycles. Further, the method includes providing the IC devices for emulation.

In one example, an emulation system includes a host system that generates control information from a circuit design and a first IC device. The first IC device emulates at least a portion of the circuit design based on the control information. The first IC device includes first detector circuitry and first concentrator circuitry. The first detector circuitry detects a change in a first signal within the first IC device, and generates a first detector signal based on the detected change in the first signal. The first concentrator circuitry outputs a first control signal indicating a stop to an emulation process of the circuit design based on the first detector signal.

In one example, a method includes receiving a circuit design and generating control information from the circuit design, and emulating, via an emulation process, the circuit design within IC devices of an emulation system based on the control information. The method further includes detecting a change in a voltage value of a first signal associated with the circuit design by a first IC device of the IC devices. Further, the method includes stopping the emulation process of the circuit design within each of the IC devices for a period based on detecting the change in the voltage value of the first signal.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A depicts a diagram of an example emulation system in accordance with some embodiments of the present disclosure.

FIG. 1B depicts a diagram of another example emulation system in accordance with some embodiments of the present disclosure.

FIG. 2 depicts a diagram of another example emulation system in accordance with some embodiments of the present disclosure.

FIG. 3 depicts a timing diagram of signals of an example emulation system in accordance with some embodiments of the present disclosure.

FIG. 4 depicts a diagram of an example multicycle path in accordance with some embodiments of the present disclosure.

FIG. 5 depicts a timing diagram of signals of a multicycle timing path in accordance with some embodiments of the present disclosure.

FIG. 6 depicts a diagram of another example emulation system in accordance with some embodiments of the present disclosure.

FIG. 7 depicts another timing diagram of signals of an example emulation system in accordance with some embodiments of the present disclosure.

FIG. 8 depicts a diagram of another example emulation system in accordance with some embodiments of the present disclosure.

FIG. 9 depicts another timing diagram of signals of an example emulation system in accordance with some embodiments of the present disclosure.

FIG. 10 depicts another timing diagram of signals of an example emulation system in accordance with some embodiments of the present disclosure.

FIG. 11 depicts a diagram of another example emulation system in accordance with some embodiments of the present disclosure.

FIG. 12 depicts a diagram of another example emulation system in accordance with some embodiments of the present disclosure.

FIG. 13 depicts a diagram of another example emulation system in accordance with some embodiments of the present disclosure.

FIG. 14 depicts a diagram of another example emulation system in accordance with some embodiments of the present disclosure.

FIG. 15 depicts another timing diagram of signals of an example emulation system in accordance with some embodiments of the present disclosure.

FIG. 16 depicts another timing diagram of signals of an example emulation system in accordance with some embodiments of the present disclosure.

FIG. 17 depicts another timing diagram of signals of an example emulation system in accordance with some embodiments of the present disclosure.

FIG. 18 depicts another timing diagram of signals of an example emulation system in accordance with some embodiments of the present disclosure.

FIG. 19A depicts a flowchart of a method of emulating a circuit design in accordance with some embodiments of the present disclosure.

FIG. 19B depicts a flowchart of a method of preparing a circuit design for emulation in accordance with some embodiments of the present disclosure.

FIG. 20 depicts a flowchart of various processes used during the design and manufacture of an integrated circuit in accordance with some embodiments of the present disclosure.

FIG. 21 depicts a diagram of an example emulation system in accordance with some embodiments of the present disclosure.

FIG. 22 depicts a diagram of an example computer system in which embodiments of the present disclosure may operate.

### DETAILED DESCRIPTION

Aspects of the present disclosure relate to dynamic control of circuit design emulation. An emulation system is used to emulate a circuit design to verify the functionality and performance of the circuit design. Emulating a circuit design allows for the circuit design to be debugged during the emulation process, correcting errors within the circuit design. An emulation system includes one or more programmable integrated circuit (IC) devices that are programmed according to the circuit design. The IC devices are field programmable gate arrays (FPGAs) or other types of programmable IC devices. Multiple IC devices are used to emulate a circuit design. Programmable hardware elements of the IC devices are programmed according to portions of the circuit design. The multiple IC devices are interconnected to allow signals to be communicated between the IC devices. The timing paths associated with the signals communicated between the IC devices cross between the IC devices. The timing paths may span two or more IC devices.

The run time performance of the emulation system when emulating a circuit design corresponds to the propagation time of the timing paths of the signals communicated between IC devices. The propagation time of the timing paths is determined by performing a static timing analysis of each signal and associated timing path within the circuit design. The run time performance of the emulation system is determined based on the longest propagation time.

In an emulation system that uses multiple IC devices to emulate a circuit design, ready network circuitry is used to synchronize the operation of the IC devices. The ready network circuitry may stop (e.g., pause) the emulation process within each of the IC devices by stopping (e.g., pausing) the local clock signals within each of the IC devices. Further, the ready network circuitry may restart (e.g., resume) the emulation process within each of the IC devices by restarting local clock signals within each of the IC devices. Synchronizing the IC devices ensures that the IC devices are synchronized with each other, preventing one IC device to function while another IC device is stopped. In one example, when a signal changes a value in one IC device, the emulation process is stopped to allow the changed signal to propagate to the target (e.g., termination) device. The ready network circuitry is used to synchronize the operation of the IC devices, such that when one IC device is stopped, all of the IC devices stop to allow the changed signal to propagate through each of the corresponding IC devices. When the propagation of the signal is completed, the ready network circuitry restarts the emulation process within each of the IC devices.

The emulation process described herein dynamically controls stopping of the emulation based on detecting changes to signals that may be communicated between IC devices. In an emulation system, the emulation process is stopped for a fixed number of emulation clock signal cycles based on an expected change to a signal to allow the changed signal to propagate to the target IC device. Accordingly, the emulation process is stopped regardless as to whether or not the expected signal change occurred. The emulation system described herein includes detector circuitry within the IC devices to detect when a change to a signal occurred. The detector circuitry is connected to the ready network circuitry within the emulation system. The emulation process is stopped based on detecting the change to the signal. Further, detector circuitry may be included within multiple IC devices connected by timing path. In such an example, the respective detector circuitry in each of the IC devices detects whether or not a change in a signal propagated to the IC device has occurred. The detector circuitry in a first IC device (e.g., a source IC device) may detect a change to a signal, and initiate a stop to the emulation process. The IC devices subsequent to the first IC device determine if the change in the signal is propagated. If the signal change is detected within a subsequent IC device, the emulation process is maintained in a stopped state. If the signal change is not detected, the emulation process is released and restarted. Accordingly, the emulation process may be stopped for a period that is shorter than the complete propagation time for a timing path of a corresponding signal.

Technical advantages of the present disclosure include, but are not limited to, reducing the run time of an emulation process, while ensuring a desired behavior of the emulated circuit design. As is noted above, the emulation system described herein dynamically detects changes to signals, and stops the emulation process based on the detection of the changes to the signals. Accordingly, as a small portion of the signals of an emulated circuit design change at any one time, an emulation system that does not employ dynamic detection of changes to signals determines the run time performance of an emulation process based on the longest propagation path, and waits (stops emulation) during every emulation cycle for that path to finish. However, by dynamically controlling the emulation process based on detected signal changes, the emulator system run time performance is improved, decreasing the amount of time used to emulate a circuit design. Decreasing the amount of time used to emulate a circuit design decreases the circuit design process time, decreasing the design and manufacturing costs of the circuit designs and corresponding semiconductor devices. Further, decreasing the amount of time used to emulate a circuit design increases the number of circuit designs that can be emulated during a given period, decreasing the design and manufacturing costs of the circuit designs and corresponding semiconductor devices.

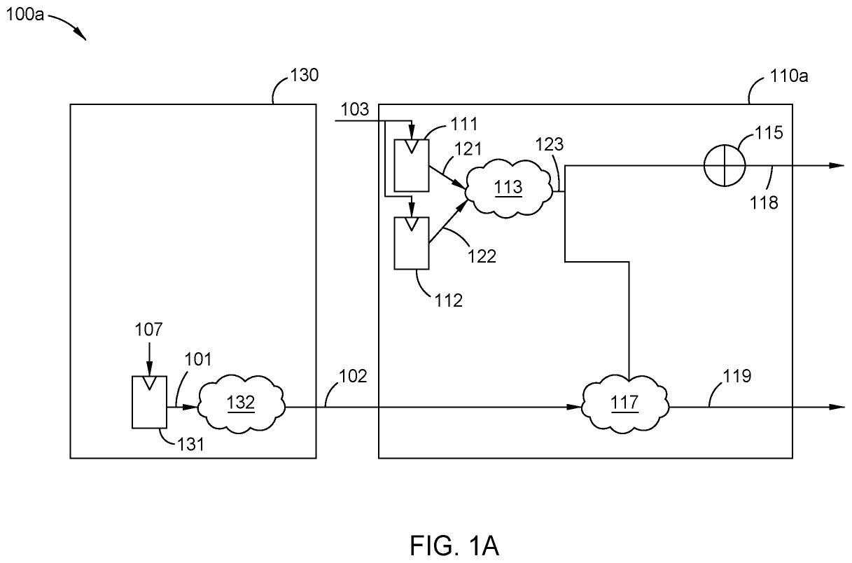

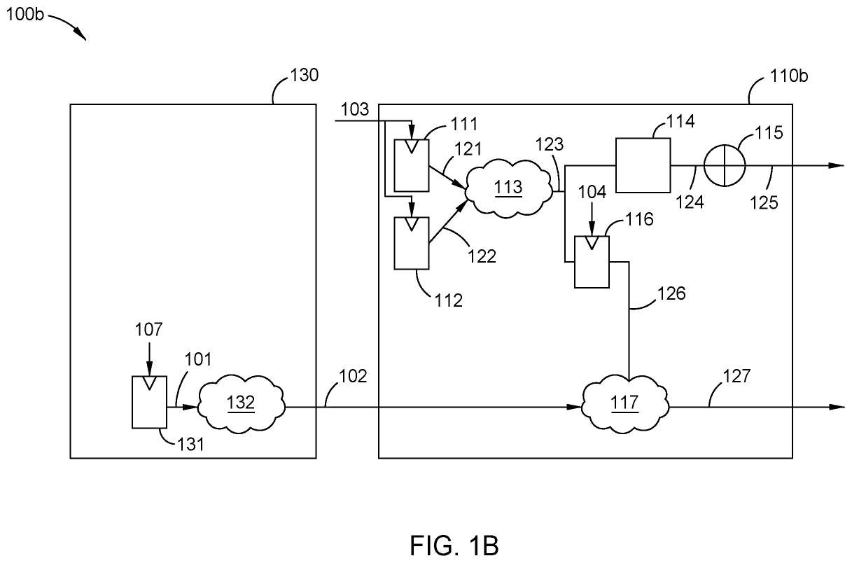

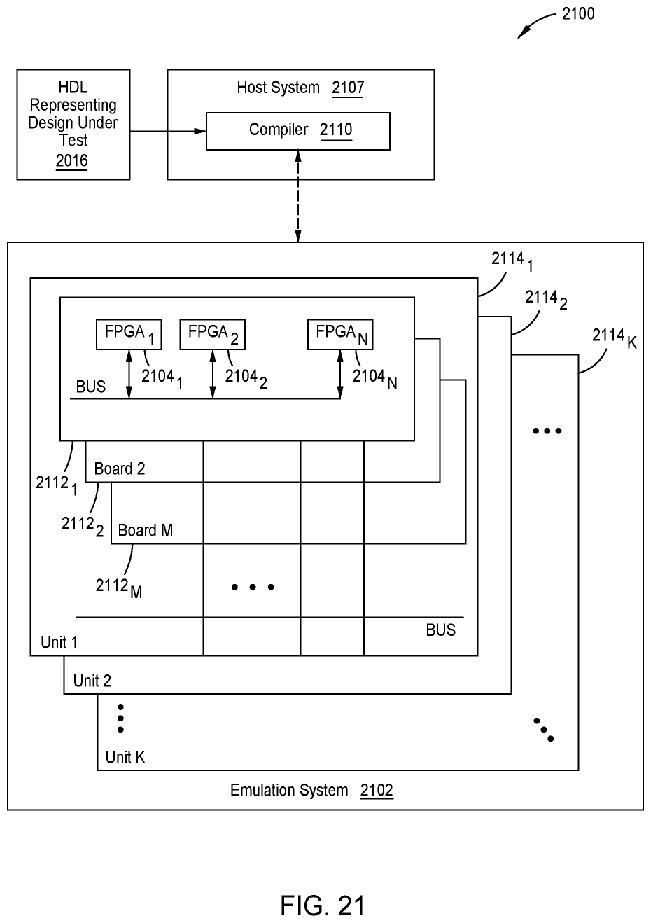

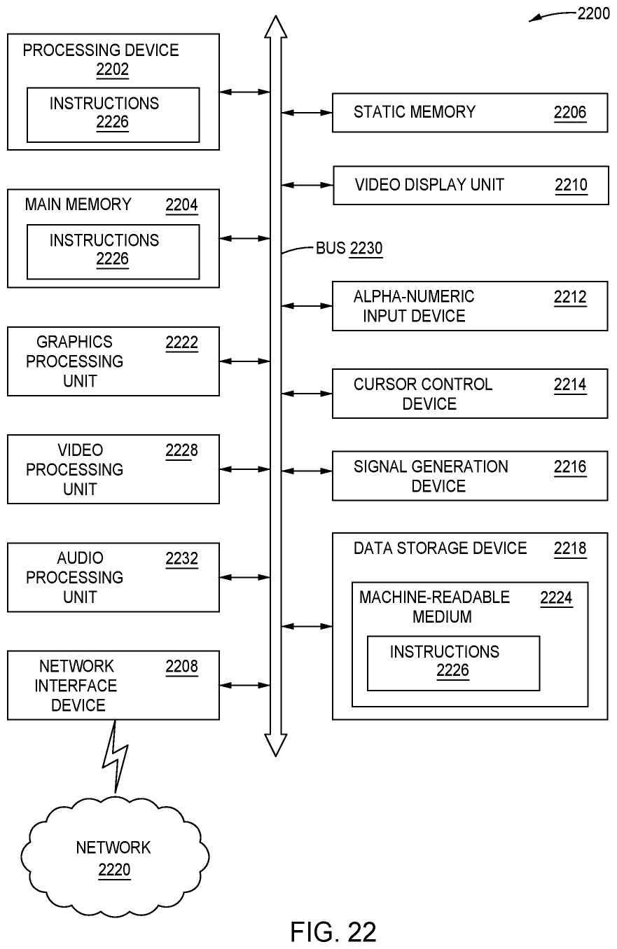

FIG. 1A illustrates a block diagram of an emulation system 100a, according to one or more examples. The emulation system 100a of FIG. 1 may be configured similar to the emulation system 2102 of FIG. 21. In one or more examples, the emulation system 100A is part of a larger emulation environment (e.g., the emulation environment 2100 of FIG. 21). As is described with further detail with regard to the emulation environment 2100 of FIG. 21, the emulation system 100a is used to verify the functionality of a circuit design (e.g., a design under test (DUT)).

As is illustrated in FIG. 1A, the emulation system 100a includes the IC device 110a and the IC device 130. The IC devices 110a and 130 are programmable devices. In one or more examples, the IC devices 110a and 130 are FPGA devices. The IC devices 110a and 130 may be configured similar to the FPGAs 2104 of FIG. 21. Each of the IC devices 110a and 130 emulate a portion of a DUT. The IC devices 110a and 130s perform a portion of the functions of the DUT to emulate the functionality of the DUT.

The IC devices 110a and 130 include one or more logic elements (e.g., logic blocks) and corresponding interconnects that are configurable to perform functions of a portion of a DUT. The circuit block elements may be configured to perform complex combinational functions, or to function as logic gates (e.g., AND gates, and OR gates, among others). The IC devices 110a and 130 may further include memory elements (e.g., registers (e.g., flip-flops) and/or more complex memory blocks).

As illustrated in FIG. 1a, the IC device 110a includes registers 111, 112, logic elements 113 and 117, and concentrator circuitry 115. The registers 111 and 112 output the signals 121 and 122. In one example, the registers 111 and 112 output the signals 121 and 122 based on a clock signal 103 (e.g., based on a rising and/or falling edge of the clock signal 103). The clock signal 103 may be generated from an emulation clock signal of the emulation system 100a. In one example, a frequency of the clock signal 103 is slower than a frequency of the emulation clock signal.

The logic elements 113 receive the signals 121 and 122 and generates the signal 123. The logic elements 113 perform one or more Boolean operations to combine the signals 121 and 122, generating the signal 123. The logic elements 113 include one or more logic gates (e.g., AND gates and/or OR gates, among others).

The signal 123 is received by the concentrator circuitry 115 and the logic elements 117. The logic elements 117 further receive the signal the signal 102 from the IC device 130. The logic elements 117 generates the signal 119 based on the signals 102 and 123. The logic elements 117 perform one or more Boolean operations on the signals 102 and 123, combining the signals 102 and 123 to generate the signal 119. In one example, the logic elements 117 include one or more logic gates (e.g., AND gates and/or OR gates, among others). The signal 119 is output from the IC device 130.

The concentrator circuitry 115 receives the signal 123 and generates the signal 118. In one example, the concentrator circuitry 115 generates the signal 118 based on the signal 123 having a specified voltage value (e.g., a high voltage value or a low voltage value). The signal 118 provides an indication to stop the emulation process after a number of clock cycles. During the number of clock cycles, the signal 123 propagates to a target circuit element.

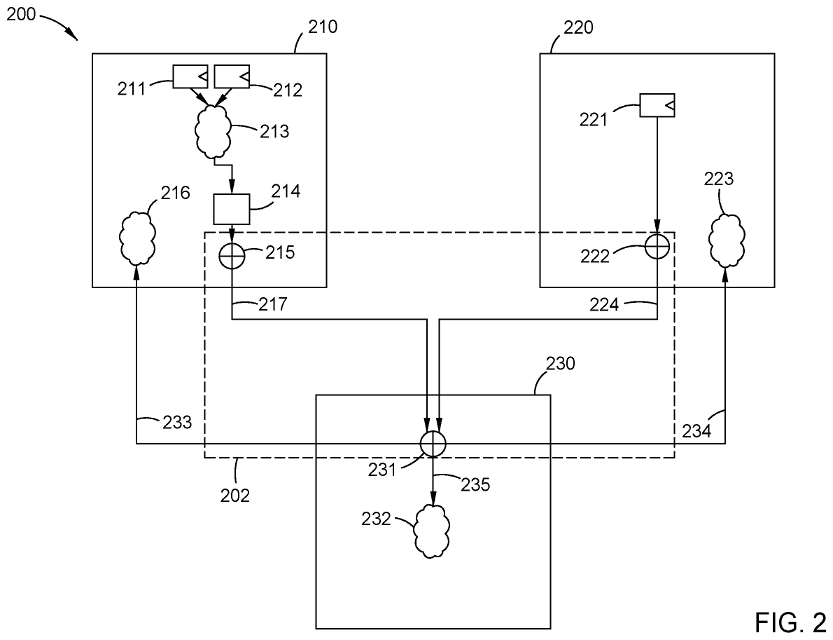

The concentrator circuitry 115 is part of ready network circuitry of the emulation system 100a. The ready network circuitry includes the concentrator circuitry of each IC device within the emulation system 100a. As is described in greater detail with regard to FIG. 2, the ready network circuitry synchronizes the emulation process (e.g., stops and restarts the emulation process) within each of the IC devices of the emulation system 100a via control signals.

The IC device 130 includes register 131 and logic elements 132. The logic elements 132 are connected to the output of the register 131 and outputs the signal 102. In one example, the register 131 outputs the signal 101 based on a clock signal 107 (e.g., based on a rising and/or falling edge of the clock signal 107). The frequency of the clock signal 107 is slower than the frequency of the emulation clock signal. The logic elements 132 are configured similar to that of the logic elements 113 and/or 117, and generate the signal 102 from the signal 101.

The timing path associated with the signal 102 crosses the boundary between the IC devices 110a and 130. The register 131 is at the beginning of the timing path, and the timing path flows through the logic elements 117 of the IC device 110.

FIG. 1B illustrates a block diagram of another emulation system 100b, according to one or more examples. The emulation system 100b of FIG. 1B is configured similar to the emulation system 2102 of FIG. 21. In one or more examples, the emulation system 100b is part of a larger emulation environment (e.g., the emulation environment 2100 of FIG. 21). As is described with further detail with regard to the emulation environment 2100 of FIG. 21, the emulation system 100b is used to verify the functionality of a circuit design (e.g., a design under test (DUT)).

As is illustrated in FIG. 1B, the emulation system 100b includes the IC device 110b and the IC device 130. The IC devices 110b and 130 are programmable devices. In one or more examples, the IC devices 110b and 130 are FPGA devices. The IC devices 110b and 130 may be configured similar to the FPGAs 2104 of FIG. 21. Each of the IC devices 110b and 130 emulate a portion of a DUT. Each of the IC devices 110b and 130 perform a portion of the functions of the DUT to emulate the functionality of the DUT.

The IC devices 110b and 130 include one or more logic elements (e.g., logic blocks) and corresponding interconnects that are configurable to perform functions of a portion of a DUT. The circuit block elements may be configured to perform complex combinational functions, or to function as logic gates (e.g., AND gates, and OR gates, among others). The IC devices 110b and 130 may further include memory elements (e.g., registers (e.g., flip-flops) and/or more complex memory blocks).

As illustrated in FIG. 1B, the IC device 110b includes registers 111, 112, logic elements 113 and 117, and concentrator circuitry 115. Further, in IC device 110b, the register 116 and the detector circuitry 114 are instrumented during emulation. Instrumenting the register 116 and the detector circuitry 114 includes adding the register 116 and the detector circuitry 114 for emulation. The register 116 and the detector circuitry 114 are not part of the original circuit design of the DUT. As is described above with regard to FIG. 1A, the registers 111 and 112 output the signals 121 and 122 based on a clock signal 103 (e.g., based on a rising and/or falling edge of the clock signal 103). The clock signal 103 may be generated from an emulation clock signal of the emulation system 100. In one example, a frequency of the clock signal 103 is slower than a frequency of the emulation clock signal.

The logic elements 113 receive the signals 121 and 122 and generates the signal 123. The logic elements 113 perform one or more Boolean operations to combine the signals 121 and 122, generating the signal 123. The logic elements 113 include one or more logic gates (e.g., AND gates and/or OR gates, among others).

In the example of FIG. 1B, the signal 123 is received by the detector circuitry 114 and the register 116. The register 116 outputs the signal 126 to the logic elements 117. In one example, the register 116 outputs the signal 126 based on a clock signal 104 (e.g., based on a rising and/or falling edge of the clock signal 104). In one example, the frequency of the clock signal 104 is slower, or the same as the frequency of the corresponding emulation clock signal. In one example, the clock signal 104 is the emulation clock signal.

The logic elements 117 receives the signal 102 from the IC device 130 and the signal 126, and generates the signal 127. The logic elements 117 perform one or more Boolean operations on the signals 102 and 126, combining the signals 102 and 126 to generate the signal 127. In one example, the logic elements 117 include one or more logic gates (e.g., AND gates and/or OR gates, among others). The signal 127 is output from the IC device 130. In one example, the signal 127 is output to another IC device within the emulation system 100b.

In one example, the detector circuitry 114 detects a change in value (e.g., a voltage transition) on the signal 123, and outputs the signal (e.g., a detector signal) 124. The signal 124 includes an indication (e.g., switches from logic 0 to logic 1) that a change in voltage value occurred in the signal 123. The change in the voltage value of the signal 123 may correspond to transition from a relatively high voltage value (logic high) to a relatively low voltage value (logic low) or a relatively low voltage value (logic low) to a high voltage value (logic high). The detector circuitry 114 may be implemented with a gate and a register on the emulator system clock. The change corresponds to a change in the voltage value of the signal 127 between emulation cycles. In one example, the signal 124 has a logic value of 1 based on detecting a change in a voltage value of the signal 127. The signal 124 has a logic value of 0 based on detecting that the voltage value of the signal 127 did not change.

In one example, based on detecting a change in the voltage value of the signal 127, the detector circuitry 114 outputs the signal 124 indicating the detected change for X cycles of the emulation clock cycle, where X is one or more. In one example, the change in voltage value during X cycles corresponds to the propagation time of the signal 127 to a target circuit element.

The concentrator circuitry 115 receives the signal 124 and generates the signal 125. In one example, the concentrator circuitry 115 generates the signal 125 based on the signal 124 indicating that the signal 123 had a change in value. In one example, the signal 125 has a logic value of 1 (e.g., a high voltage value) based on the signal 124 indicating (e.g., having a logic value of 1) that a change in the signal 123 occurred.

In one example, the concentrator circuitry 115 outputs the signal 125 indicating a stop to the emulation process for one or more cycles of the emulation clock cycle. In one example, the concentrator circuitry 115 stops the emulation process for a number of cycles that corresponds to the propagation time of the signal 127 to a target circuit element.

During an emulation process, the propagation time of the timing path associated with the signal 101, 102, and 127 may negatively affect the performance of the emulation process. In one example, the emulation process is stopped during each cycle of the emulation process to allow the signal 101 to propagate from the register 131 to the target (e.g., destination) circuit element. Further, as is illustrated by FIG. 1B, the logic elements 117 receive the signal 126 that is generated based on the signal 121 and 122. The voltage value of the signal 127 may be changed based on the voltage value of the signal 126. Accordingly, the propagation time of the timing path associated with signal 126 further includes the propagation time of the signal 126 (e.g., the propagation time associated with the signals 121, 122, and 123). However, as the voltage value of the signal 126 may change infrequently, e.g., not during each cycle of the emulation process, stopping the emulation process during each cycle to account of the propagation time of the timing path associated with the signal 126 may negatively affect performance during the emulation process. For example, the emulation process may be stopped during cycles during which the voltage value of the signal 126 does not change, reducing performance of the emulation process (e.g., increasing the amount of time of the emulation process).

As is illustrated in FIG. 1B, the IC device 110b includes detector circuitry 114 and concentrator circuitry 115. As is noted above, the detector circuitry 114 detects changes to the voltage value (e.g., a logic state) of the signal 123, and the concentrator circuitry 115 outputs a control signal 125. The control signal 125 includes an indication that the signal 123 changed in voltage value, and is used to stop emulation within the emulation system 100b. For example, the control signal 125 is received by the concentrator circuitry of another IC device, which generates a control signal that is communicated to all other IC devices to stop the emulation process within the emulation system 100. Stopping the emulation process based on a change in the voltage value of the signal 123 (and based on the control signal 125), allows the emulation process to continue to run when the voltage value of the signal 123 does not change, and to be stopped when the voltage value of the signal 123 changes. Accordingly, the run time performance of the emulation system 100b is improved, reducing the time spent emulating the DUT.

FIG. 2 illustrates an emulation system 200, according to one or more examples. The emulation system 200 includes IC devices 210, 220, and 230. The emulation system 200 is configured similar to that of the emulation system 100b of FIG. 1B. The IC device 210 includes registers 211, 212, logic elements 213 and 216, detector circuitry 214, and concentrator circuitry 215. The registers 211, 212 are configured similar to the registers 111 and 122 of FIG. 1B, the logic elements 213 and 216 are configured similar to the logic elements 113 of FIG. 1B, the detector circuitry 214 is configured similar to the detector circuitry 114 of FIG. 1B, and the concentrator circuitry 215 is configured similar to the concentrator circuitry 115 of FIG. 1B.

The IC device 220 includes register 221, concentrator circuitry 222, and logic elements 223. The register 221 is configured similar to the registers 111 and 122 of FIG. 1B, the logic elements 216 are configured similar to the logic elements 113 of FIG. 1B, and the concentrator circuitry 215 is configured similar to the concentrator circuitry 115 of FIG. 1B.

The IC device 230 includes concentrator circuitry 231, and logic elements 232. The logic elements 232 are configured similar to the logic elements 113 of FIG. 1B, and the concentrator circuitry 231 is configured similar to the concentrator circuitry 115 of FIG. 1B. The concentrator circuitries 215 and 222 output corresponding control signals to the concentrator circuitry 231. The concentrator circuitry 231 outputs control signals 233-235 to the logic elements 216, 223, and 232 respectively.

In one example, the registers 211 and 212 output signals to the logic elements 213, and the logic elements 213 output a signal to the detector circuitry 214 based on the signals output by the registers 211 and 212. In one example, the logic elements 213 includes a logic gate (e.g., an AND gate, OR gate, or XOR gate, among others) that receives the signals output by the registers 211 and 212 and outputs a signal to the detector circuitry 214. The detector circuitry 214 determines if there is a change in the voltage value of the signal and generates and outputs a signal to the concentrator circuitry 215. The concentrator circuitry 215 outputs the control signal 217 indicating that the signal output by the logic elements 213 had a change in voltage value.

The concentrator circuitry 222 outputs the control signal 224 based on the signal output by the register 221. The concentrator circuitry (e.g., root collector circuitry) 231 receives the control signals 217 and 224, and generates the control signals 233, 234, and 235. The concentrator circuitry 231 generates the control signals 233, 234, and 235 based on the control signals 217 and/or 224. In one example, based on the control signal 217 indicating that the signal output by the logic elements 213 has a change in voltage value, the concentrator circuitry 231 generates the control signals 233, 234 and 235 to stop the emulation process (e.g., to stop the logic elements 216, 223, and 232) within the emulation system 200.

The concentrator circuitries 215, 222, and 231 form ready network circuitry that synchronizes the IC devices 210, 220, and 230 during an emulation process. For example, the concentrator circuitry 215 may output the control signal 217 to the concentrator circuitry 231 that indicates a stop in the emulation process. The concentrator circuitry 231 outputs control signals 233, 234, and 235 that instruct the corresponding IC devices 210, 220, and 230 to stop the emulation process. Further, the concentrator circuitry 231 may output the control signals 233, 234, and 235 to instruct the IC devices 210, 220, and 230 to resume the emulation process. In one example, the control signals 233, 234, and 235 include an instruction to pause the emulation process along with a period of time (e.g., a number of emulation cycles) to stop the emulation process.

In one example, stopping the emulation process stops the clock signals that drive the registers 211, 212, and 221, and the logic elements 213, 216, 223, and 232.

In one or more examples, before the emulation process is performed, static timing analysis is performed on the timing paths of each of the signals. When performing a static timing analysis of the propagation of signals within the emulation system 200, static timing analysis is applied to the timing path associated with the control signals 217, 224, 233, 234, and 235 to determine the corresponding propagation times. For example, static timing analysis is performed on the propagation of the signals starting from each local contributor (e.g., registers 211 and 212 or 221), through the concentrator circuitry 231, and back to the final consumers of the signals (e.g., the logic elements 216, 223, or 232).

In one example, T is the longest amount time for the ready network to compute any event that stops the emulation process (e.g., from a source IC device 210, 220 or 230 to all other IC devices 210, 220, and/or 230) through the concentrator circuitry 231. In one example, the timing paths whose propagation time is larger than T are detected. Further, the signals that are included in the computation of those timing paths and that are fully supported by a register (or registers) within an IC device are determined. With further reference to FIG. 1B, the timing path associated with signal 127 is determined to have a total propagation time larger than T. Further, the voltage value of the signal 123 may alter the voltage value of the signal 127. Accordingly, as the signal 123 is locally generated within the IC device 110, the detector circuitry 114 is included within the signal path of the signal 123, between the output of the logic elements 113 and the concentrator circuitry 115. Further, the register 116 is included within the signal path of the signal 123 between the logic elements 113 and the logic elements 117. The register 116 is included to break the timing path between the output of the logic elements 113 and the logic elements 117. Including the register 116 provides time for the detector circuitry 114 to determine whether a change in the voltage value of the signal 123 occurred. Accordingly, when a change in the voltage value in the signals 123 occurs, the change is detected by the detector circuitry 114 and the signal 124 indicating the change is output to the concentrator circuitry 115. The concentrator circuitry 115 outputs a signal indicating a pause (or stop) to the emulation process to root collector concentrator circuitry within the corresponding ready network circuitry (e.g., the concentrator circuitry 231 of FIG. 2). The detected change in the voltage value of the signal 123 corresponds to a change in the voltage value between the current emulation cycle and a previous emulation cycle. In one example, a period of an emulation cycle is determined as the longest path static timing associated with the DUT. The static timing may be determined via timing analysis performed on the DUT. The period of the fastest clock signal used during an emulation process is based on the longest path static timing.

In one example, the ready network circuitry latency is not increased as only signals with local registers are instrumented (e.g., analyzed by detector circuitry). Accordingly, the ready network circuitry propagation time is not increased by the instrumentation.

The signal 123 may be a multi-cycle path (MCP). For example, the signal 123 is generated based on a clock signal 103 (or clock signals) that has a frequency that is slower than that of the emulation clock signal. The frequency of the signal 123 is N times slower than the frequency of the emulation clock signal. N is two or more. As the detector circuitry 114 is included to detect changes in the voltage value of the signal 123, static timing analysis performed on the emulation system 100b determines the propagation time of the timing path of the signal 123. The propagation time may be used during run time of the corresponding emulation process. In one or more examples, the timing path corresponding to the signal 123 is omitted from determining the propagation path of the critical path within the corresponding circuit design.

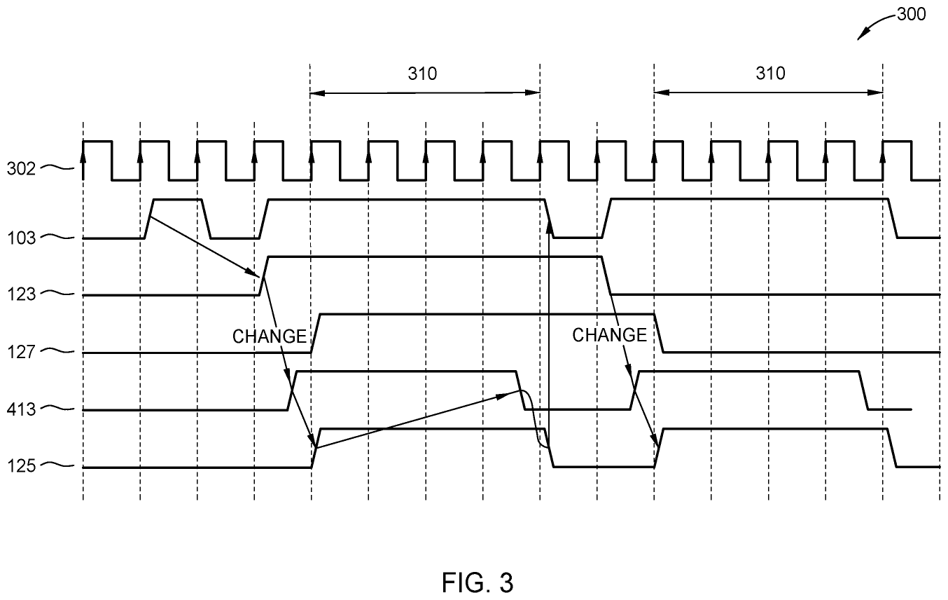

FIG. 3 illustrates a timing diagram 300, according to one or more examples. FIG. 3 illustrates the emulation clock signal 302. The emulation clock signal 302 may be the emulation clock signal for the emulation system 100b of FIG. 1B. As can be seen from FIG. 3, a cycle (e.g., a rising edge and corresponding falling edge) of the clock signal 103 corresponds to more than one cycle of the emulation clock signal 302. Further, in the timing diagram of FIG. 3, the propagation time (T2) of the timing path of the signal 123 is less than four cycles of the corresponding emulation clock signal.

As depicted in FIG. 3, the signal 127 changes on a positive edge of the clock signal 103 (e.g., a slow clock signal or a multicycle clock signal) at runtime. The detector circuitry 114 propagates the change to the ready network circuitry (e.g., the concentrator circuitry 115), which stops emulation for 4 cycles of the emulation clock signal 302 (e.g., period 310). The change in the signal 127 is propagated to a target circuit element during the period 310. At the end of the period 310, the detector circuitry 114 releases the ready network circuitry (e.g., the concentrator circuitry 115), which allows for emulation to restart. The timing diagram 300 depicts two consecutive changes, stopping the emulation process for 4 cycles during each period (e.g., periods 310 and 312). The number of cycles is based on the propagation time T2.

Due to the activity properties of DUTs in the emulation process, the probability at any given emulation cycle that an instrumented timing path is active (e.g., a change in value of a corresponding signal) is very low. Accordingly, using detector circuitry (e.g., the detector circuitry 114 of FIG. 1) to detect the changes of a value of a signal of a timing path speed ups up the emulation process as compared to an emulation process that relies on static timing analysis to determine a fixed emulation cycle period to stop the emulation process.

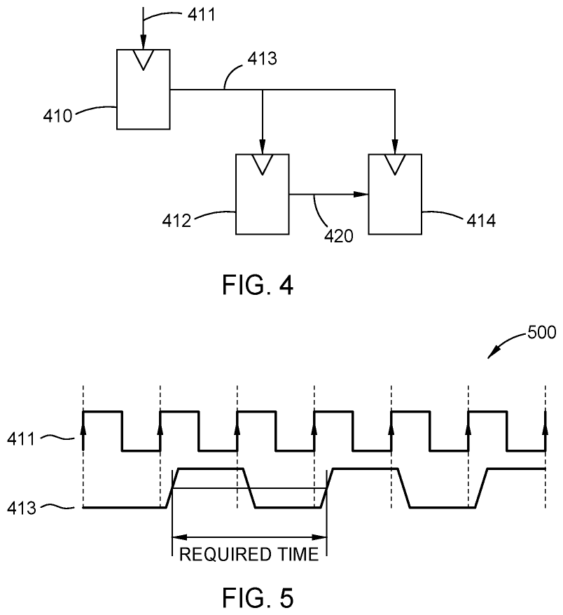

As is noted above, MCPs are timing paths associated with signals that correspond to clock signals having a slower frequency than that of the emulation clock signal (e.g., the emulation clock signal 302 of FIG. 3). FIG. 4 illustrates a data path 420 that is a MCP.

In FIG. 4, the clock signal 411 is an emulation clock signal and is received by the register 410. The register 410 generates the clock signal 413 from the clock signal 411. The frequency of the clock signal 411 determines the maximum run time performance of an emulation process of a corresponding DUT. The timing path described by the ready network circuitry in FIG. 2 is an example of a path that finishes within one cycle of the emulation clock signal. In a DUT, slower clock signals are defined via the structural properties of the DUT. When a timing path exists between two logic elements that are driven by a clock signal having frequency that is slower than the frequency of the clock signal 411, the propagation time of that timing path spans multiple cycles of the clock signal 411. Such a timing path is a MCP. FIG. 5 illustrates a timing diagram 500 of the clock signal 411 and the clock signal 413. As the data path 420 is driven based on the clock signal 413, the propagation time of the data path 420 is at least two cycles of the clock signal 411. The clock signal 413 is a derived clock signal that is at most changing at every positive edge (or negative edge) of the clock signal 411. A signal is transmitted via the data path 420 between logic elements (registers) 412 and 414 based on a positive edge (or negative edge) of the clock signal 413 and captured by the circuit element 414 on the same positive edge (or negative edge). As the signal on the data path 420 is output and captured based on the clock signal 413, which has a frequency that is slower than that of the clock signal 411, the data path 420 is a MCP.

FIG. 5 is a timing diagram 500 of the clock signals 411 and 413. As can be seen from FIG. 5, the clock signal 413 transitions based on positive edges of the clock signal 411. Accordingly, one cycle (e.g., a positive edge and subsequent negative edge) of the clock signal 413 corresponds to two clock cycles (e.g., two positive edges) of the clock signal 411. Stated another way, each positive edge and falling edge of the clock signal 413 corresponds to a rising edge of the clock signal 411, and the clock signal 413 does not have a voltage transition aligned with a negative edge of the clock signal 411. While the clock signal 413 is illustrated and described as having voltage transitions that are aligned with positive edges and not negative edges of the clock signal 411, in other examples, the voltage transitions of the clock signal 413 are aligned with negative edges and not positive edges of the clock signal 411.

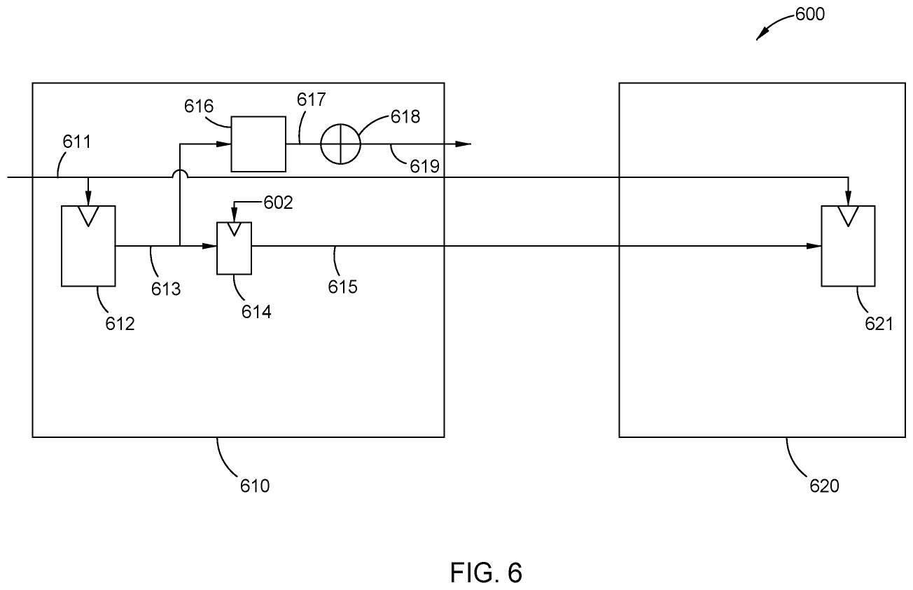

FIG. 6 illustrates another emulation system 600, according to one or more examples. The emulation system 600 is configured similar to the emulation system 100b of FIG. 1B. The emulation system 100b includes IC device 610 and IC device 620. The IC devices 610 and 620 are connected to each other. The IC devices 610 and 620 are configured similar to the IC devices 110b and 130 of FIG. 1B. The IC device 610 includes registers 612, 614, detector circuitry 616, and concentrator circuitry 618. The registers 612 and 614 are configured similar to the registers 111 and 112 of FIG. 1B, the detector circuitry 616 is configured similar to the detector circuitry 114 of FIG. 1B, and the concentrator circuitry 618 is configured similar to the concentrator circuitry 115. The IC device 620 includes register 621. The register 621 is configured similar to the register 111 and 112 of FIG. 1B.

The register 612 outputs the signal 613 based on the clock signal 611. The signal 613 is received by the register 614 and the detector circuitry 616. The register 614 outputs the signal 615 based on the clock signal 602. The signal 615 is received by the register 621 of the IC device 620. The register 621 receives the signal 615 based on the clock signal 611. The detector circuitry 616 outputs the signal 617 indicating a change (or no change) to the voltage value of the signal 613 to the concentrator circuitry 618. The concentrator circuitry 618 outputs the control signal 619 based on the signal 617. The control signal 619 is output to the concentrator circuitry of the corresponding ready network circuitry, which uses the control signal 619 to stop (e.g., pause) the emulation process. If the signal 617 is indicative of a change in the voltage value of the signal 613, the control signal 619 indicates an emulation process stop (e.g., pause) request. If the signal 617 is not indicative of a change in the voltage value of the signal 613, the control signal 619 does not indicate an emulation process stop request.

In FIG. 6, the clock signal 611 has a frequency that is less than that of an emulation clock signal of the emulation system 600. In one example, the clock signal 611 is derived from the emulation clock signal. Accordingly, the timing path corresponding to the clock signal 611 is a MCP. In one example, the frequency of the clock signal 611 is at least two times slower than the emulation clock signal. For example, one cycle of the clock signal 611 corresponds to at least two cycles of the emulation clock signal.

As the clock signal 611 is MCP, and the frequency of the clock signal 611 is at least two times slower than that of the emulation clock signal, a change in the voltage value to the signal 615 takes at least four cycles of the emulation clock signal to reach the register 621.

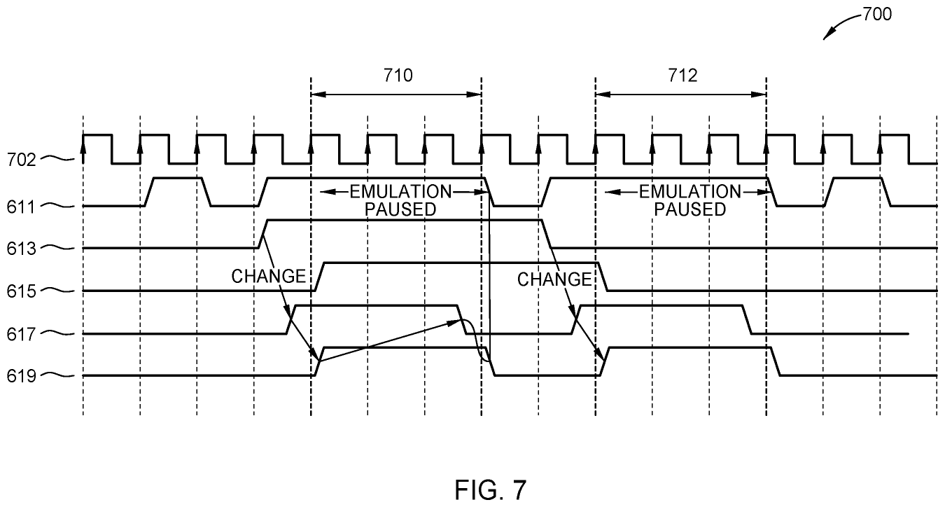

FIG. 7 illustrates a timing diagram 700 of the signals of the emulation system 600 of FIG. 6. As is illustrated in FIG. 7, one cycle of the clock signal 611 occurs before the signal 613 has a change in value. The detector circuitry 616 detects the change in value of the signal 613 and outputs the signal 617 having a value of one. Accordingly, the control signal 619 changes in a voltage value to have a value of one. The control signal 619 having a value of one indicates a pause to the emulation process occurring during periods 710 and 712. Each of the periods 710 and 712 corresponds to four cycles of the emulation clock signal 702, which is based on the propagation time of the signal 615. The propagation time of the signal 615 is determined via static timing analysis performed on the corresponding timing path.

The detector circuitry 616 maintains the signal 617 at a logic value of one (e.g., a value indicating that a change in the voltage value of the signal 613 occurred) for four cycles of the emulation clock signal 702 (e.g., a period corresponding to the propagation time of the signal 615). At the end of the four cycles of the emulation clock signal 702, the detector circuitry 616 outputs the signal 617 having a logic value of zero (e.g., releases the emulation process). The detector circuitry 616 outputs the signal 617 having a value of logic one based on detecting that the signal 613 has a change in a voltage value from one to zero. Accordingly, the emulation process is paused during the period 712, and for four cycles of the emulation clock signal 702.

In one or more examples, the larger the MCP value and the smaller propagation time for a data path (e.g., T2), the less time the emulation process is stopped. In one or more examples, the emulation process is stopped after one or more cycles of the emulation clock signal based on the voltage value of MCP. A general formulation of support for MCP is provided as following.

In an emulation system that does not include detector circuitry, the instrumented path can be defined with T emulation cycles to propagate, derived from the relationships of the clock signal source and destination. Tmin is defined to be (T2/Emulation Period). Tmin is the minimum number of emulation cycles for the propagation path of interest to propagate once instrumented for detecting changes in the voltage value of the corresponding signals, since T2 corresponds to the arrival time after instrumentation. At runtime, the emulation process is stopped for T_stop=Tmin−T+1. When T, the structural multicycle property of the timing path, is one then the solution is equivalent to the description of FIG. 1B. However, when Tis greater than one, the emulation process is stop for fewer cycles of the emulation clock cycle, further improving the overall run time of the emulation process.

In one or more examples, the ready network circuitry is pipelined such that propagation paths instrumented with multi cycles of T can be postponed stopping (or pausing) the emulation process for N−1 cycles. Such a process further improves latency of ready network circuitry as seen by the static timing analysis, further improving the run time of the emulation process. Further, multiple instrumented paths may be overlapped at run time.

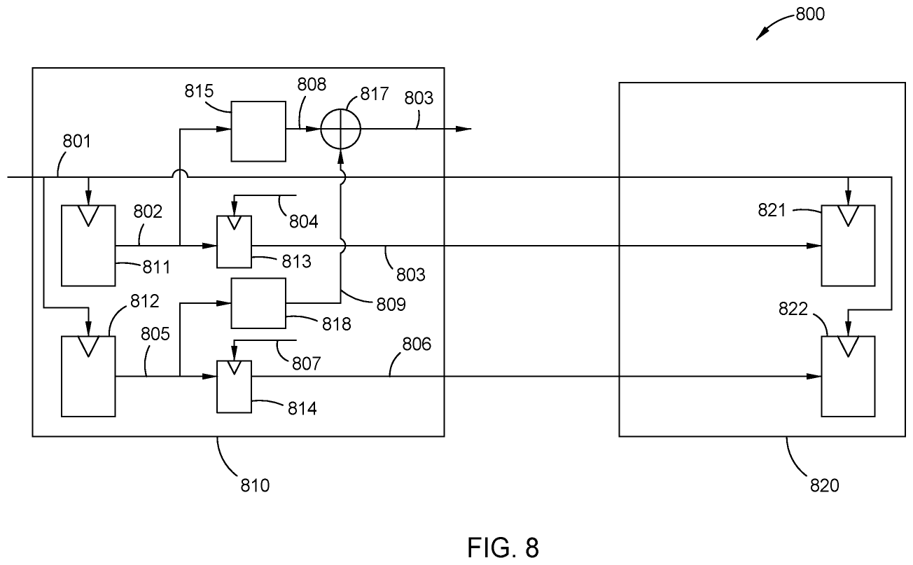

FIG. 8 illustrates another emulation system 800, according to one or more examples. The emulation system 800 is configured similar to the emulation system 100b of FIG. 1B. The emulation system 800 includes IC device 810 and IC device 820. The IC device 810 is connected to the IC device 820. In one example, the IC device 810 outputs the control signals 803 and 806 via respective data paths to the IC device 820. The IC devices 810 and 820 are configured similar to the IC devices 110b and 130 of FIG. 1B.

The IC device 810 includes registers 811-814, detector circuitries 815 and 818, and concentrator circuitry 817. The registers 811-814 are configured similar to the registers 111 and 112 of FIG. 1B, the detector circuitries 815 and 818 are configured similar to the detector circuitry 114 of FIG. 1B, and the concentrator circuitry 817 is configured similar to the concentrator circuitry 115 of FIG. 1B.

The registers 811 and 812 receive the clock signal 801, and respectively output the signals 802 and 805 based on the clock signal 801. The clock signal 801 has a frequency that is slower than the frequency of the emulation clock signal of the emulation system 800. In one example, the clock signal 801 is at least two times slower than the frequency of the emulation clock signal. The signal 802 is received by the detector circuitry 815.

The detector circuitry 815 outputs the signal 808, indicating whether or not the voltage value of the signal 802 changed. The signal 805 is received by the detector circuitry 818. The detector circuitry 818 outputs the signal 809, indicating whether or not the voltage value of the signal 805 changed.

The concentrator circuitry 817 outputs the control signal 803 based on the signal 808 and/or 809. The control signal 803 indicates whether or not to stop the emulation process based on a change in value of the signal 802 and/or 805. The register 813 outputs the control signal 803 based on the signal 802 and the clock signal 804. The clock signal 804 is received by the register 821 of the IC device 820 based on the clock signal 801. The register 814 outputs the signal 806 based on the signal 805 and the clock signal 807. The signal 806 is received by the register 822 of the IC device 820 based on the clock signal 801. In one example, the clock signals 804 and 801 are the emulation clock signal of the emulation system 800. In one example, the propagation time of the data path associated with the control signal 803 and the propagation time of the data path associated with the signal 806 corresponds to four cycles of the emulation clock signal. In other examples, the propagation time may be less than or larger than four cycles of the emulation clock signal.

In one example, the voltage value of the signal 802 (and the control signal 803) changes before the voltage value of the signal 805 (and the signal 806). Accordingly, the emulation process stops based on the change in the voltage value of the signal 802 and also based on the change in value of the signal 805. For example, at a first voltage transition (e.g., positive edge or negative edge) of the clock signal 801, the voltage value of the signal 802 changes and at a second transition of the clock signal 801, the voltage value of the signal 805 changes. The second voltage transition is subsequent to the first voltage transition.

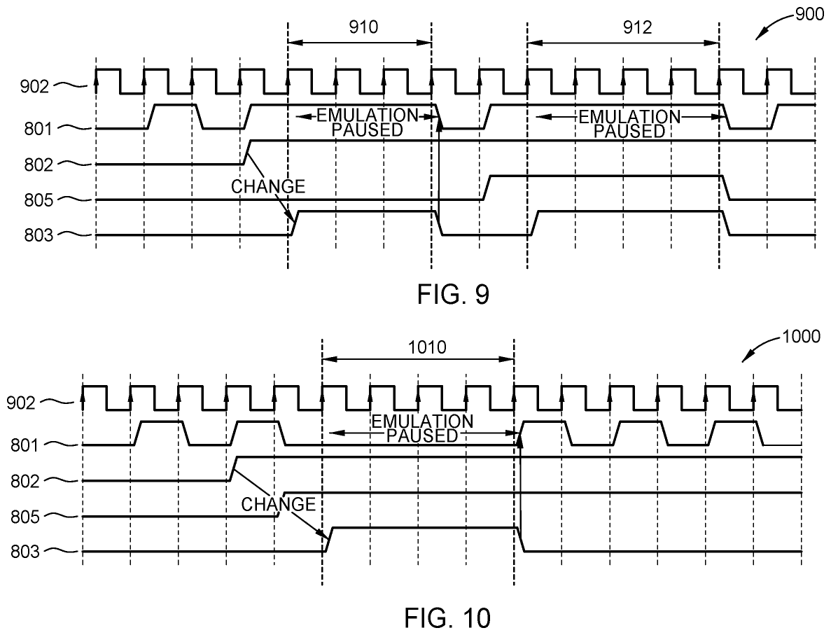

FIG. 9 illustrates a timing diagram 900 of the signals of the emulation system 800. The timing diagram 900 includes emulation clock signal 902 (e.g., the emulation clock signal of the emulation system 800). In the timing diagram 900, the control signals 803 and 806 are not pipelined. In the timing diagram 900, the emulation process of the emulation system 800 is stopped (e.g., paused) during periods 910 and 912. The emulation process of the emulation system 800 is stopped based on detecting changes to both signals 802 and 805. For example, the emulation process is stopped based on detecting a change in the voltage value of the signal 802 during period 910 and based on detecting a change in the voltage value of the signal 805 during period 912.

FIG. 10 illustrates a timing diagram 1000 of the signals of the emulation system 800. As compared to the timing diagram 1000, in the timing diagram 900, the emulation process is stopped during the period 1010, which is shorter in duration (e.g., associated with stopping emulation for fewer cycles) than the combination of the periods 910 and 912 of FIG. 9. In the timing diagram 1000, changes to the voltage values of the signals 802 and 805 at least partially overlap in time (e.g., are at least partially parallelized), such that stopping of the emulation process due to the changes to the voltage values of the signals 802 and 805 at least partially overlap in time (e.g., are at least partially parallelized). As the propagation time for the signal 802 is larger than the MCP value of the signal 805 (e.g., the signal 805 changes value before the signal 802 is received as the control signal 803 by the register 821), stopping of the emulation process is delayed, allowing the voltage value of the signal 805 to change. Accordingly, the detector circuitries 815 and 818 detect a change in values to the signals 802 and 803 during at least partially overlapping periods, and the emulation process is stopped based on the changes during a common period, e.g., the period 1010 of timing diagram 1000. As compared to the timing diagram 900, the emulation process is stopped for a shorter period of time (e.g., less cycles of the emulation clock signal 902) in the timing diagram 1000, reducing the run time of the corresponding emulation process.

In one or more examples, the propagation paths associated with each of the IC devices of an emulation system are analyzed using a static timing analysis method to determine how many emulation clock cycles after a change in a corresponding signal occurs that the emulation process is stopped. Each of the propagation paths is classified based on the corresponding number of emulation clock cycles. Additionally, or alternatively, the propagation paths may be classified based on the properties of the clock signals of source and target synchronous elements. In one example, when the relationship of source and target clock signals have an MCP relationship, that relationship is used to determine in how many cycles emulation need to be stopped. The IC devices are categorized based on the classification of the associated propagation paths. In one example, instead of including a detector circuitry per IC device, a detector circuitry may be included in each category of IC device.

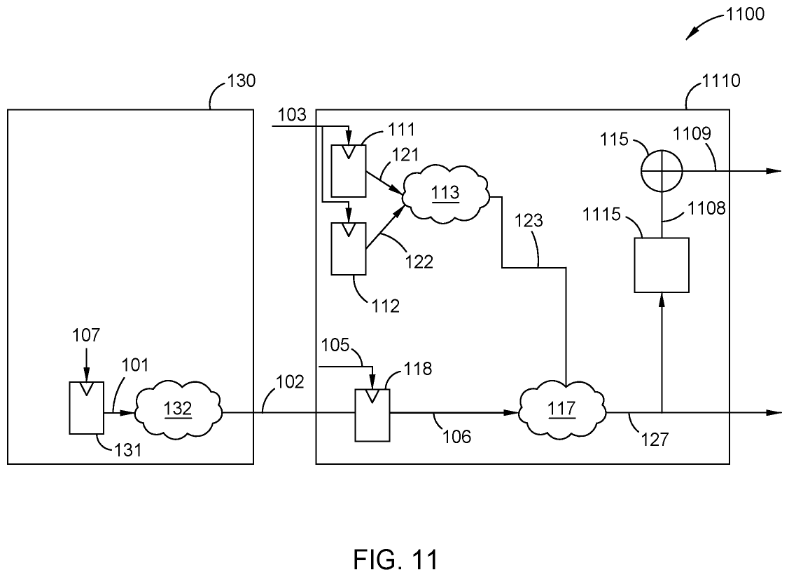

FIG. 11 illustrates another emulation system 1100, according to one or more examples. The emulation system 1100 is configured similar to the emulation system 100b of FIG. 1B. The emulation system 1100 includes IC device 1110 and 130. The output of the IC device 130 is connected to an input of the IC device 1110. The IC device 1110 is configured similar to the IC device 110b. For example, the IC device 1110 includes detector circuitry 1115. However, as compared to the detector circuitry 114 of the IC device 110b, the detector circuitry 1115 of FIG. 11 is connected to the output to receive the signal 127 of the IC device 1110. Connecting the detector circuitry 1115 at the output of the IC device 1110 (and the output of the logic elements 117) mitigates instances where a change in a value of the signal 123 is detected that would not change the voltage value in signal 127. For example, if the logic elements 117 is an OR logic gate and the voltage value of the signal 106 is a logic one, the voltage value of the signal 127 is controlled by the voltage value of the signal 106, and the voltage value of the signal 123 does not affect the voltage value of the signal 127. Accordingly, in such an example, when the voltage value of the signal 123 changes to a value of one, the detector circuitry 114 and concentrator circuitry 115 of FIG. 1B stops the emulation process. However, as in such an example the signal 123 does not change the voltage value of the signal 127, stopping the emulation process based on a change in a value of the signal 123 adds latency to the emulation process. Further, in an example where a change in the voltage value of the signal 106 occurs, the emulation process is stopped, and stopping the emulation process based on a change in the voltage value of the signal 123 does not occur.

As is illustrated in FIG. 11, the detector circuitry 1115 generates the signal 1108 indicative of whether or not a value of the signal 127 changed. For example, based on a change in value of the signal 127, the detector circuitry 1115 generates the signal 1108 indicating that the voltage value of the signal 127 changed. Accordingly, the concentrator circuitry 115 outputs the control signal 1109 that indicates that the signal 127 had a change in value. Accordingly, the emulation process is stopped by the corresponding ready network circuitry.

In one example, the register 1118 is a d-latch flip-flop that is driven by the clock signal 105. The register is added during instrumentation, and is not included in the original circuit design. In one example, the clock signal 105 is the emulation clock signal. In such an example, the register 1118 is closed for a short period at the end of each system clock. The period may be considered to be negligible with respect to the period of the clock signal 105. Accordingly, closing the register 1118 does not significantly affect the propagation time of the corresponding timing path (e.g., the timing path associated with the signals 102, 106, and 127). The register 1118 may be a virtual sampling register that does not have a physical implementation. In other words, the static timing analysis is given a point in the circuit design where to stop timing propagation, instead of using a physical register that uses resources. The register 1118 captures the timing path associated with the signal 102 and 106, which can be considered a false path. For example, a false path may correspond to when a change to the signal 102 propagates to the input of the IC device 1110, and the change would have been detected at the output of the IC device 130 and emulation stopped during a given system clock cycle. In one or more examples, the timing path including the signal 106 and the signal 127 is accounted for as delay is added to the ready network circuitry of the emulator system 100. For example, delay may be added in an example when the voltage value of the signal 102 does not change, and, accordingly, the sampled value of the register 1118 can be used to determine whether or not a value of the signal 127 changed.

In one or more examples, each of the IC devices (e.g., the IC devices 110b and 130 of FIG. 1B, and/or the IC devices 1110 and 130 of FIG. 11) of an emulation system (e.g., the emulation system 100b of FIG. 1B and/or the emulation system 1100 of FIG. 11) include corresponding detector circuitry and concentrator circuitry. In such an example, each of the IC devices of an emulation system detect signal voltage value changes locally with each respective IC device, and generates a respective control signal to indicate to stop a (e.g., pause) the emulation process.

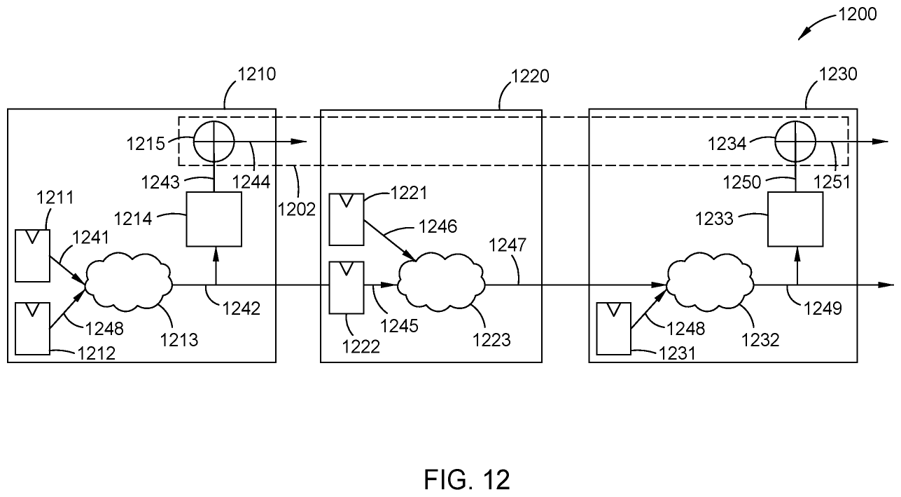

FIG. 12 illustrates another example emulation system 1200, according to one or more examples. The emulation system 1200 is configured similar to the emulation system 100b of FIG. 1B. The emulation system 1200 includes IC device 1210, IC device 1220, and IC device 1230. The IC devices 1210, 1220, and 1230 are programmable devices. In one or more examples, the IC devices 1210, 1220, and 1230 are FPGA devices. The IC devices 1210, 1220, and 1230 may be configured similar to the FPGAs 2104 of FIG. 21. Each of the IC devices 1210, 1220, and 1230 emulate a portion of a DUT. The IC devices 1210, 1220, and 1230 perform a portion of the functions of the DUT to emulate the functionality of the DUT.

The IC devices 1210, 1220, and 1230 are interconnected such that a timing path associated with the signals 1240, 1241, 1242, 1245, 1246, 1247, 1248, and 1249 passes through and between the IC devices 1210, 1220, and 1230.

The IC device 1210 includes registers 1211 and 1212, logic elements 1213, detector circuitry 1214, and concentrator circuitry 1215. The registers 1211 and 1212 are configured similar to the registers 111 and 112 of FIG. 1B, the logic elements 1213 are configured similar to the logic elements 113 and 117 of FIG. 1B, the detector circuitry 1214 is configured similar to the detector circuitry 114 of FIG. 1B, and the concentrator circuitry 1215 is configured similar to the concentrator circuitry 115 of FIG. 1B.

The register 1211 outputs the signal 1241 and the register 1212 outputs the signal 1240 based on a local clock signal. The local clock signal has a frequency that is slower than a frequency of the emulation clock signal. The registers 1211 and 1212 may be driven based on the same local clock signal, which has a frequency slower than that of the emulation clock signal. In one example, the registers 1211 and 1212 are driven based on respective clock signals that each have a frequency slower than that of the emulation clock signal. The logic elements 1213 receive the signals 1240 and 1241 and generates the signal 1242. In one example, the logic elements 1213 include gate logic elements (e.g., an AND gate and/or an OR gate, among others). The gate logic elements perform one or more Boolean operations (e.g., an AND operation and/or OR operation, among others) on the signals 1240 and 1241 to generate the signal 1242.

The detector circuitry 1214 receives the signals 1242 and detects a change in the voltage value of the signal 1242 between emulation cycles. The detector circuitry 1214 generates the signal 1243 based on whether or not the voltage value of the signal 1242 changed. The signal 1242 includes an indication (e.g., a corresponding voltage value) as to whether or not a change in value of the signal 1242 occurred between emulation cycles.

The concentrator circuitry 1215 receives the signal 1243 and generates the control signal 1244 form the signal 1243. In one example, the control signal 1244 includes an indication as whether or not the voltage value of the signal 1242 was detected to have changed. The concentrator circuitry 1215 is part of ready network circuitry 1202 of the emulation system 1200. The control signal 1244 is output to another concentrator circuitry (e.g., a collector concentrator circuitry) of the ready network circuitry 1202 to indicate as to whether or not the emulation process is be stopped. In one example, the control signal 1244 provides an indication to stop the emulation process based on the detector circuitry 1214 detecting a change in a value of the signal 1242 between emulation cycles.

The IC device 1220 receives the signal 1242 from the IC device 1210. The IC device 1220 includes registers 1221 and 1222, and logic elements 1223. The registers 1221 and 1222 are configured similar to the registers 111 and 112 of FIG. 1B, the logic elements 1223 are configured similar to the logic elements 113 and 117 of FIG. 1B, and the concentrator circuitry 1215 is configured similar to the concentrator circuitry 115 of FIG. 1B.

The register 1221 generates the signal 1246 and the register 1222 outputs the signal 1245 based on one or more respective local clock signals. The local clock signal or signals have a frequency that is slower than the frequency of the emulation clock signal of the emulation system 1200. The logic elements 1223 receive the signals 1245 and 1246 and generates the signal 1247. In one example, the logic elements 1223 include gate logic elements (e.g., an AND gate and/or an OR gate, among others). The gate logic elements perform one or more Boolean operations (e.g., an AND operation and/or OR operation, among others) on the signals 1245 and 1246 to generate the signal 1247.

The IC device 1230 receives the signal 1247 from the IC device 1220. The IC device 1230 includes register 1231, logic elements 1232, detector circuitry 1233, and concentrator circuitry 1234. The register 1231 is configured similar to the registers 111 and 112 of FIG. 1B, the logic elements 1223 are configured similar to the logic elements 113 and 117 of FIG. 1B, the detector circuitry 1233 is configured similar to the detector circuitry 114 of FIG. 1B, and the concentrator circuitry 1234 is configured similar to the concentrator circuitry 115 of FIG. 1B.

The register 1231 generates the signal 1248 based on a local clock signal. The local clock signal has a frequency that is slower than the frequency of the emulation clock signal. The logic elements 1232 receive the signals 1247 and 1248 and generates the signal 1249. In one example, the logic elements 1232 include gate logic elements (e.g., an AND gate and/or an OR gate, among others). The gate logic elements perform one or more Boolean operations (e.g., an AND operation and/or OR operation, among others) on the signals 1247 and 1248 to generate the signal 1249.

The detector circuitry 1233 receives the signal 1249 and detects a change in the voltage value of the signal 1249 between emulation cycles. The detector circuitry 1233 generates the signal 1250 based on whether or not the voltage value of the signal 1249 changed. The signal 1250 includes an indication as to whether or not a change in value of the signal 1249 occurred between emulation cycles.

The concentrator circuitry 1234 receives the signal 1250 and generates the control signal 1251 from the signal 1250. In one example, the control signal 1251 includes an indication as whether or not the voltage value of the signal 1249 was determined to have changed. The concentrator circuitry 1234 is part of the ready network circuitry 1202 of the emulation system 1200. The ready network circuitry of the emulation system 1200 may include concentrator circuitries of other IC devices within the emulation system 1200.

The control signal 1244 is output to the collector concentrator circuitry of the ready network circuitry 202 to indicate as to whether or not the emulation process is be stopped. In one example, the control signal 1244 provides an indication to stop the emulation process based on the detector circuitry 1214 detecting a change in a value of the signal 1242 between emulation cycles.

The timing path associated with the signals 1242, 1247, and 1249 is a MCP as the local clock signals used to generate the signals 1240, 1241, 1246, 1245, and 1248 have a frequency that is less than the frequency of the emulation clock circuitry. The local signals are derived from the emulation clock signal. A cycle of each of the local clock signals corresponds to (e.g., spans) two or more cycles of the emulation clock signal.

In one or more examples, the signals 1242 and 1249 include a delay large enough (e.g., at least one emulation clock cycle) to allow the detector circuitries 1214 and 1233 to receive and detect changes within the corresponding signals 1241 and 1249. The delay in the signal 1247 is small enough as to not negatively affect the operation of the detector circuitries 1214 and 1233 during an emulation clock signal cycle.

The signal 1249 is generated based on the signal 1247 and 1248. Accordingly, a change in value to the signal 1247 may not propagate to the signal 1249. Therefore, if detector circuitry was added to the IC device 1220 to detect a change in the signal 1247, a control signal may be sent to stop the emulation process during emulation cycles where stopping the emulation process during that emulation cycle is not needed, latency is added to the emulation process and negatively affects the run time of the emulation process.

In one or more examples, the register 1222 is a sampling register. Including the register 1222 as a sampling register in the IC device 1220 allows for a value sampled by the register 1222 to be used to detect a change in the voltage value of the signal 1249. If the register 1222 was included in the IC device 1230, a change in the voltage value of the signal 1247 originating in the register 1221 may propagate to the output of the IC device 1220 via the signal 1247, and the sampled value may not be used to detect a change in a value to the signal 1249 in IC device 1230. For example, as the IC device 1220 is not able to stop the emulation process as the IC device 1220 does not include detector circuitry and concentrator circuitry. Including the register 1222 at the input of the IC device 1220, the detection of a change in value to the signal 1249 is not local to the IC device 1220. In such an example, the delay of the propagation path between the IC device 1220 and the IC device 1230 that is associated with the signal 1247 is added to the delay of the corresponding ready network circuitry.

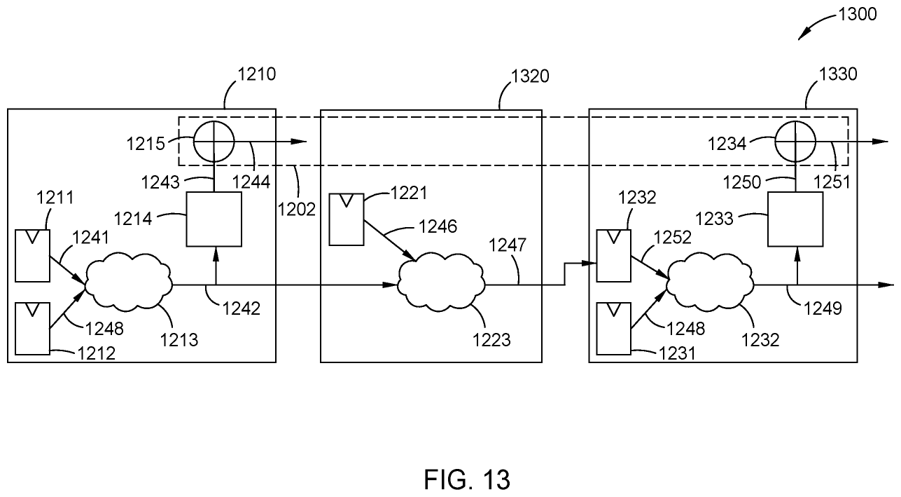

FIG. 13 illustrates another emulation system 1300, according to one or more examples. The emulation system 1300 is configured similar to that of the emulation system 1200 of FIG. 12. For example, the emulation system 1300 includes IC devices 1210, 1320, and 1330. The IC devices 1320 and 1330 are configured similar to the IC devices 1220 and 1230 of FIG. 12. For example, the IC device 1320 includes the register 1221 and the logic elements 1223. However, as compared to the IC device 1220 of FIG. 12, the IC device 1320 omits the register 1222. In the IC device 1320, the logic elements 1223 receives the signal 1242 from the logic elements 1213 of the IC device 1210 and the signal 1246 from the register 1221, and generates the signal 1247. The voltage value of the signal 1247 reflects the voltage value of the signal 1242 and the signal 1246.

In one or more examples, depending on the MCP factor N associated with the timing path of the signals 1242, 1247, and 1249, stopping of the emulation process is delayed by up to N−1 cycles. Based on the timing of the corresponding circuit design, the register 1222 is used to preserve locality of change detection. In an example where the register 1222 is included, the detection of a change in signal value becomes valid after added latency (e.g., one or more emulation clock signal cycles), but no delay between the IC devices 1210, 1220, and 1230 is added to the corresponding ready network circuitry. The change detection by the detector circuitry 1233 is accurate when no voltage change to the signal 1242 occurs. In the example of FIG. 13, detection of a change to the signal 1247 happens after one cycle of latency.

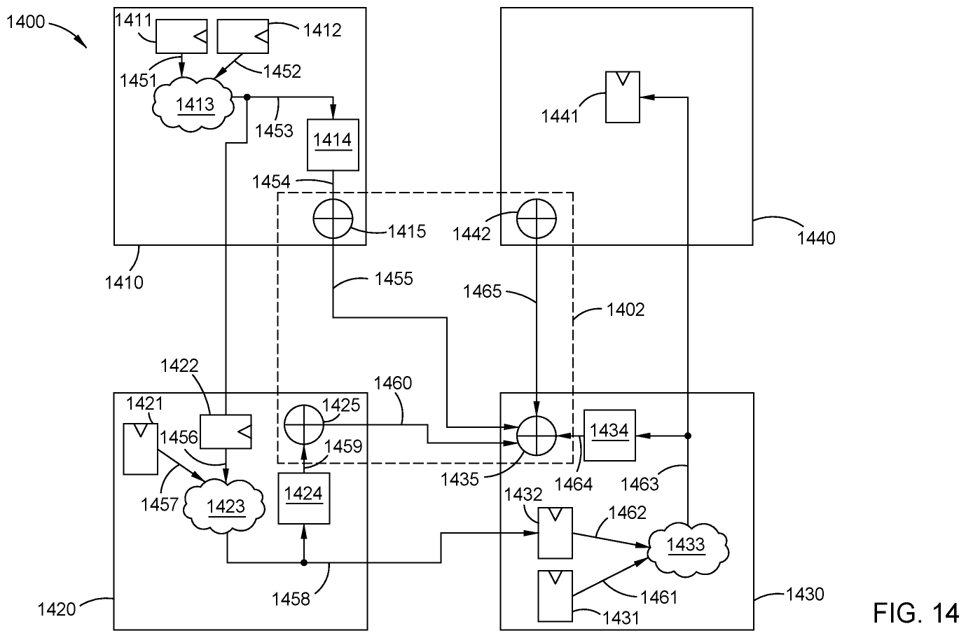

FIG. 14 illustrates another emulation system 1400, according to one or more examples. The emulation system 1400 is configured similar to the emulation system 100b of FIG. 1B.

The emulation system 1400 includes IC devices 1410, 1420, 1430, and 1440. The IC devices 1410, 1420, 1430, and 1440 are configured similar to the IC devices 110b and 130 of FIG. 1B. The IC device 1410 is connected to the IC device 1420 via a first timing path, the IC device 1420 is connected to the IC device 1430 via a second timing path, the IC device 1430 is connected to the IC device 1440 via a third timing path. The IC devices 1410, 1420, 1430, and 1440, and corresponding timing paths form a combinational timing path.

The IC device 1410 includes registers 1411, 1412, logic elements 1413, detector circuitry 1414, and concentrator circuitry 1415. The registers 1411 and 1412 are configured similar to the registers 111 and 112 of FIG. 1B. The logic elements 1413 are configured similar to the logic elements 113 and 117 of FIG. 1B. The detector circuitry 1414 is configured similar to the detector circuitry 114 of FIG. 1B. The concentrator circuitry 1415 is configured similar to the concentrator circuitry 115 of FIG. 1B.

The register 1411 outputs the signal 1451, and the register 1412 outputs the signal 1452. The register 1411 outputs the signal 1451 and the register 1412 outputs the signal 1452 based a local clock signal or local clock signals. In one example, the registers 1411 and 1412 output the signals 1451 and 1452 based on the same local clock signal. In other examples, the register 1411 outputs the signal 1451 based on a first local clock signal, and the register 1412 outputs the signal 1452 based on a second local clock signal. The second local clock signal differs from the first local clock signal. In one example, the local clock signal (or signals) have a frequency that is less than a frequency of the emulation clock signal of the emulation system 1400. Accordingly, the timing paths associated with the signals 1451 and 1452 are MCPs. Further, the downstream timing paths, e.g., the timing paths associated with the signal 1453, are MCPs.

The logic elements 1413 receives the signals 1451 and 1452, and generates the signal 1453. For example, the logic elements 1413 performs one or more Boolean operations, and/or other operations, to combine the signals 1451 and 1452 to generate the signal 1453.

The detector circuitry 1414 receives the signal 1453 and generates the signal 1454 based on a determination as to whether or not a value of the signal 1453 changed between emulation cycles. The signal 1454 includes an indication as to whether or not the voltage value of the signal 1453 changed between emulation cycles. In one example, the signal 1454 has a value of logic one (e.g., a high voltage value) based on a change in the voltage value of the signal 1453 being detected between emulation cycles. The signal 1454 has a value of logic zero (e.g., a low voltage value) based on a change in the voltage value of the signal 1453 not being detected between emulation cycles.

The concentrator circuitry 1415 receives the signal 1454 and generates the signal 1455. The signal 1455 includes an indication (e.g., a value of logic one or a high voltage value) to stop (e.g., pause) the emulation process based on the signal 1454 indicating that a change in the signal 1453 occurred between emulation cycles. The signal 1455 does not include an indication (e.g., a value of zero or a low voltage value) to stop the emulation process based on the signal 1454 not indicating that a change in the signal 1453 occurred between emulation cycles.

The IC device 1420 includes registers 1421, 1422, logic elements 1423, detector circuitry 1424, and concentrator circuitry 1425. The registers 1421 and 1422 are configured similar to the registers 111 and 112 of FIG. 1B. The logic elements 1423 are configured similar to the logic elements 113 and 117 of FIG. 1B. The detector circuitry 1424 is configured similar to the detector circuitry 114 of FIG. 1B. The concentrator circuitry 1425 is configured similar to the concentrator circuitry 115 of FIG. 1B.

The register 1421 outputs the signal 1457 based a local clock signal. In one example, the local clock signal has a frequency that is less than a frequency of the emulation clock signal of the emulation system 1400. Accordingly, the timing path associated with the signal 1457 is a MCP. Further, the downstream timing paths, e.g., the timing paths associated with the signal 1458 and 1459, are MCPs.

The register 1422 receives the signal 1453 and outputs the signal 1456. The register 1422 samples the signal 1453 and generates the signal 1456 from the samples based on the emulation clock signal.

The logic elements 1423 receives the signals 1456 and 1457, and generates the signal 1458. For example, the logic elements 1413 performs one or more Boolean operations, and/or other operations, to combine the signals 1456 and 1457 to generate the signal 1458.

The detector circuitry 1424 receives the signal 1458 and generates the signal 1459 based on a determination as to whether or not a value of the signal 1458 changed between emulation cycles. The signal 1459 includes an indication as to whether or not the voltage value of the signal 1458 changed between emulation cycles. In one example, the signal 1459 has a value of logic one based on a change in the voltage value of the signal 1458 being detected between emulation cycles. The signal 1459 has a value of logic zero based on a change in the voltage value of the signal 1458 not being detected between emulation cycles.

The concentrator circuitry 1425 receives the signal 1459 and generates the signal 1460. The signal 1460 includes an indication (e.g., a value of logic one) to stop (e.g., pause) the emulation process based on the signal 1460 indicating that a change in the signal 1458 occurred between emulation cycles. The signal 1460 does not include an indication (e.g., a value of zero) to stop the emulation process based on the signal 1459 not indicating that a change in the signal 1458 occurred between emulation cycles.

The IC device 1430 includes registers 1431, 1432, logic elements 1433, detector circuitry 1434, and concentrator circuitry 1435. The registers 1431 and 1432 are configured similar to the registers 111 and 112 of FIG. 1B. The logic elements 1433 are configured similar to the logic elements 113 and 117 of FIG. 1B. The detector circuitry 1434 is configured similar to the detector circuitry 114 of FIG. 1B. The concentrator circuitry 1435 is configured similar to the concentrator circuitry 115 of FIG. 1B.

The register 1431 outputs the signal 1461 based a local clock signal. In one example, the local clock signal has a frequency that is less than a frequency of the emulation clock signal of the emulation system 1400. Accordingly, the timing path associated with the signal 1461 is a MCP. Further, the downstream timing paths, e.g., the timing paths associated with the signal 1463 and 1464, are MCPs.

The register 1432 receives the signal 1458 and outputs the signal 1462. The register 1432 samples the signal 1458 and generates the signal 1462 from the samples of the signal 1458 based on the emulation clock signal.

The logic elements 1433 receives the signals 1462 and 1461, and generates the signal 1463. For example, the logic elements 1433 performs one or more Boolean operations, and/or other operations, to combine the signals 1461 and 1462 to generate the signal 1463.

The detector circuitry 1434 receives the signal 1463 and generates the signal 1464 based on a determination as to whether or not a value of the signal 1463 changed between emulation cycles. The signal 1464 includes an indication as to whether or not the voltage value of the signal 1463 changed between emulation cycles. In one example, the signal 1434 has a value of logic one based on a change in the voltage value of the signal 1463 being detected between emulation cycles. The signal 1464 has a value of logic zero based on a change in the voltage value of the signal 1463 not being detected between emulation cycles.

The IC device 1440 includes register 1441 and concentrator circuitry 1442. The register 1441 is configured similar to the registers 111 and 112 of FIG. 1B. The concentrator circuitry 1442 is configured similar to the concentrator circuitry 115 of FIG. 1B.

The register 1441 receives the signal 1463 from the IC device 1430. The register 1441 is the target device (e.g., termination point) for the timing path associated with signal 1463. The concentrator circuitry 1442 generates the control signal 1465. The concentrator circuitry 1415, the concentrator circuitry 1425, the concentrator circuitry 1435, and the concentrator circuitry 1442 form the ready network circuitry 1402.

The concentrator circuitry 1435 receives the signal 1464 and control signals 1455, 1460, and 1465, and determines whether or not to stop the emulation process of the emulation system 1400. In one example, based on an indication within the signal 1464 that a value of the signal 1463 changed between emulation cycles, the concentrator circuitry 1435 determines to stop the emulation process of the emulation system 1400. Further, based on an indication within one or more of the signals 1455, 1460, and 1465 to stop the emulation process, the concentrator circuitry 1435 determines the emulation process is to be stopped and communicates corresponding signals to the IC devices 1410, 1420, 1440 and within the IC device 1430 to stop the emulation process within each of the IC devices 1410, 1420, 1430, and 1440. The concentrator circuitry 1435 is root collector circuitry that synchronizes the emulation process within each of the IC devices 1410, 1420, 1430, and 1440 based on the signal 1464, and the control signals 1455, 1460, and 1465.

In one example, a change in either of the signals 1451 and 1452, or to a signal along the corresponding timing path may not always propagate to the register 1441, or another target within the IC devices 1410, 1420, 1430, and 1440. When a change in one of the signals is detected (e.g., detected by one or more of the detector circuitries 1414, 1424, and 1434), the emulation process is stopped during a period that is long enough to allow the change to propagate all the way to a corresponding target or targets. In one or more examples, the length of the period is very conservative, and can negatively affect the efficiency (e.g., throughput) of the emulation process.

In one example, the duration of the period for which the emulation process is stopped is dynamically determined based on the propagation of a signal change (e.g., transition) through the corresponding timing path. For a change is detected at by one or more of the detector circuitries 1414, 1424, and 1434, instead of stopping the emulation process for a period having a duration based on the complete outgoing timing path, the emulation process is stopped during a period long enough to allow for the next downstream detection to happen. For example, if the detector circuitry 1414 detects a change in the signal 1453, the emulation process is stopped for a period that is long enough to allow the detector circuitry 1424 (e.g., which is downstream from the detector circuitry 1414) to analyze and determine whether or not a change in the signal 1458 occurred. Stopping the emulation process for a period long enough to allow the subsequent downstream detector circuitry to analyze the corresponding signal, the change is signal is allowed to propagate to the next detection point at the downstream detector circuitry along the timing path, where the change in the corresponding signal is detected, and the downstream detector circuitry maintains a stop on the emulation process. For example, the detector circuitry 1414 detects a change in the signal 1453 and stops the emulation process for a period long enough for the detector circuitry 1424 to analyze and determine whether or not a change in the signal 1458 occurred. Based on the detector circuitry 1424 detecting a change in the signal 1458, the detector circuitry 1424 stops the emulation process for a period long enough to allow the detector circuitry 1434 to analyze and determine whether or not a change occurred within the signal 1463. Based on the detector circuitry 1434 detecting a change in the signal 1463, the emulation process is stopped for a period long enough to allow the signal 1463 to propagate to the register 1441.

If any of the downstream detector circuitries (e.g., the detector circuitries 1424 and 1434) do not detect a change in a respective signal (e.g., the signal 1458 or 1463), the corresponding detector circuitry does not indicate a stop to the emulation process as the propagation of the signal change has stopped and that there is no need to stop the emulation process further at this point.

In one or more examples, stopping the emulation process includes stopping the local clock signal or signals of the registers 1411, 1412, 1421, and 1431. The duration of the period for which the emulation process is stopped (e.g., the local clock signal or signals are stopped) is controlled with a resolution based on cycles of the emulation clock signal.

In FIG. 13, the combinational path includes interconnections between the IC devices 1410, 1420, 1430, and 1440. To provide the proposed dynamic emulation stop duration, each of the detector circuitries 1414, 1424, and 1434 stops the emulation process for a period long enough to allow for the propagation to reach the following downstream detector circuitry. At any emulation clock cycle, if a change is detected by the detector circuitry 1414, the detector circuitry 1414 stops the emulation process long enough for the signal change to propagate to the detector circuitry 1424. If the signal change propagates to the detector circuitry 1424, the detector circuitry 1424 maintains the stop to the emulation process for a period long enough for the signal change to propagate to the detector circuitry 1434. If no signal change is detected by the detector circuitry 1424, the detector circuitry 1424 does not maintain the stop to the emulation process. Further, based on the detector circuitry 1434 detecting a change in the signal 1463, the detector circuitry 1434 stops the emulation process for a period long enough for the signal change to propagate to the register 1441 (e.g., target register).

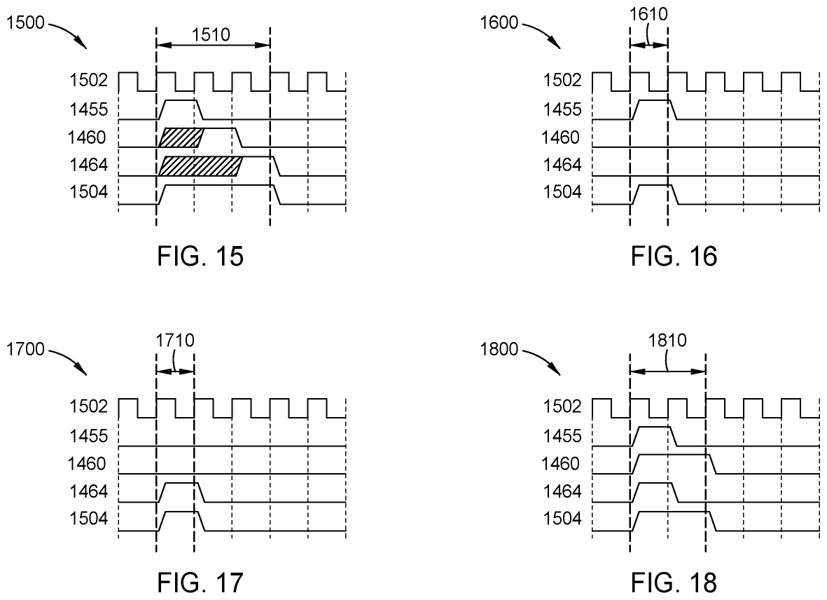

FIG. 15 illustrates a timing diagram 1500 of the waveforms of the emulation system 1400. For example, the timing diagram 1500 includes emulation clock signal 1502 of the emulation system 1400, the control signals 1455, and 1460, the signal 1464, and the control signal 1504. The control signal 1504 is a control signal that is provided to the IC devices 1410, 1420, 1430, and 1440 to stop the emulation process. The control signal 1504 is generated by the concentrator circuitry 1435 based on the control signals 1455 and 1460, and the signal 1464. In the timing diagram 1500, the control signals 1455 and 1460, and the signal 1464 are indicative of a signal change and a request to stop the emulation process. Accordingly, the control signal 1504 indicates a stop to the emulation process for period that corresponds to each of the control signals 1455 and 1460 and the dynamic signal 1464 indicating a stop to the emulation process. In one example, the emulation process is stopped for period 1510 that corresponds to each of the control signals 1455 and 1460 and the signal 1464 indicating a stop to the emulation process. Each of the control signals 1455 and 1460 and the signal 1464 stop the emulation process for a cycle of the emulation clock signal 1502. Accordingly, the control signal 1504 stops the emulation process for three cycles of the emulation clock signal 1502 during the period 1810. The period 1810 corresponds to the full timing path between the IC device 1410 and the IC device 1440 of FIG. 14. At the end of the period 1810, the stop request of the emulation process is released, and the emulation process is resumed.

With reference to FIG. 14, during the period 1510, a change in the signal 1453 propagates to the register 1441. The control signal 1455 maintains a logic value of 1 for a period long enough (e.g., one cycle of the emulation clock signal 1502) for the detector circuitry 1424 to detect a change in the signal 1458. The control signal 1460 maintains a logic value of one for a period long enough (e.g., one cycle of the emulation clock signal 1502) for the detector circuitry 1434 to detect a change in the signal 1463. The signal 1464 maintains a logic value of one for a period long enough (e.g., one cycle of the emulation clock signal 1502) for the signal 1463 to propagate to the register 1441. The control signal 1504 maintains a logic value of one for a period corresponding to the controls signals 1455 and 1460 and the signal 1464 having a logic value of one.

FIG. 16 illustrates a timing diagram 1600 of the waveforms of the emulation system 1400. For example, the timing diagram 1600 includes emulation clock signal 1502 of the emulation system 1400, the control signals 1455, and 1460, the signal 1464, and the control signal 1504.

FIG. 16 illustrates an example where a signal transition (e.g., a signal change) starting from register 1411 propagates to the signal 1453 and the output of the IC device 1410, but stops propagating in the IC device 1420, and does not reach the signal 1458 and the output of the IC device 1420. All other signals along the timing path associated with the signal 1453 remain constant (e.g., do not change). Accordingly, during the cycle of the emulation clock signal 1502, the concentrator circuitry 1415 outputs a control signal to stop the emulation process. At the next cycle of the emulation clock signal 1502, the detector circuitry 1424 does not detect a signal change and does not need to issue a stop request for the emulation process. Accordingly, the emulation process is resumed at the next cycle. The period 1610 is the period during which the emulation process is stopped.

FIG. 17 illustrates a timing diagram 1700 of the waveforms of the emulation system 1400. For example, the timing diagram 1700 includes emulation clock signal 1502 of the emulation system 1400, the control signals 1455, and 1460, the signal 1464, and the control signal 1504. FIG. 17 depicts an example where a signal transition (e.g., signal change) starting from the register 1431 propagates as the signal 1463 and is output by the IC device 1430, and is received by the register 1441 of the IC device 1440. Considering that all other signals output by the IC devices 1410 and 1420 remain constant, then a clock cycle associated with the period 1710, the detector circuitry 1434 issues a stop request via the signal 1464 and the concentrator circuitries 1415 and 1425 do not issue stop requests during the period 1710. At the following emulation clock signal 1502 cycle, the signal 1463 is propagated and reaches the register 1441, no further change is detected, and the emulation process is resumed at the next cycle of the emulation clock signal 1502.

FIG. 18 illustrates a timing diagram 1800 of the waveforms of the emulation system 1400. For example, the timing diagram 1800 includes emulation clock signal 1502 of the emulation system 1400, the control signals 1455, and 1460, the signal 1464, and the control signal 1504. FIG. 18 depicts an example where the signals 1453, 1458, and 1463 change (e.g., transition) during the period 1810. Accordingly, the detector circuitries 1414, 1424, and 1434 detect the change and corresponding emulation stop requests are issued as the control signals 1455 and 1460. Further, as is illustrated by the timing diagram 1800, the control signal 1460 is indicative of a change in the signal 1458, and a stop to the emulation process during all of the period 1810. The control signal 1455 and the signal 1464 indicate a stop (e.g., has a logic value of one) to the emulation process during a first cycle of the period 1810 and not during the second cycle of the period 1810 (e.g., has a logic value of 0). At the end of the period 1810, the change to the signal 1458 does not propagate to the signal 1463, and the stop to the emulation process is released, and the emulation process is resumed during the emulation clock signal cycle following the period 1810.

In one or more examples, the present system and process to dynamically control the duration for which the emulation process is stopped (e.g., the local clock signal or signals are stopped) improves throughput of the corresponding emulation system as compared to a process that using a statically determined stop duration that accounts for the worst case possible (e.g., is based on the entire propagation path). The granularity at which the emulation stop duration can be dynamically controlled is that of a cycle of the emulation clock signal. In one example, at any individual detection point (e.g., a detector circuitry), the only difference is the duration for which a stop request is issued. Instead of accounting for the longest outgoing timing path, the duration of an individual stop emulation request is limited by the longest distance to the next detection point(s) (e.g., detector circuitry) present on the outgoing timing path(s). This results in the duration of an individual stop clock request to be lesser than or equal to the propagation time of the longest outgoing timing path.

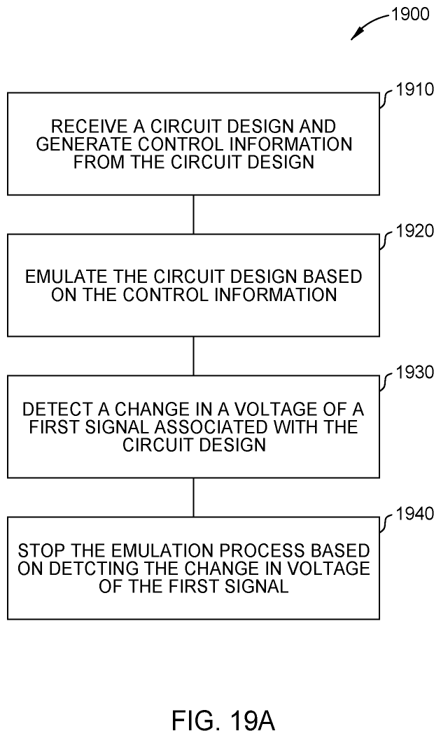

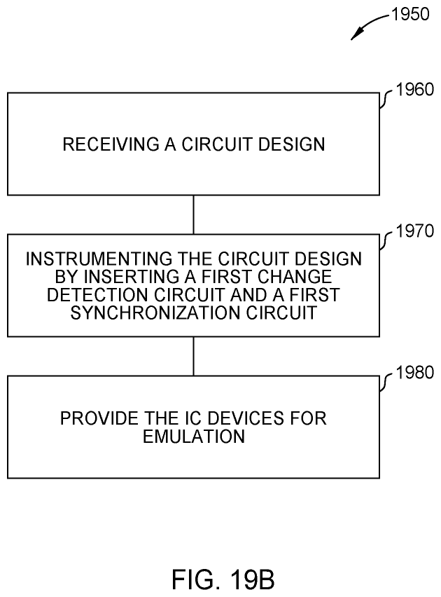

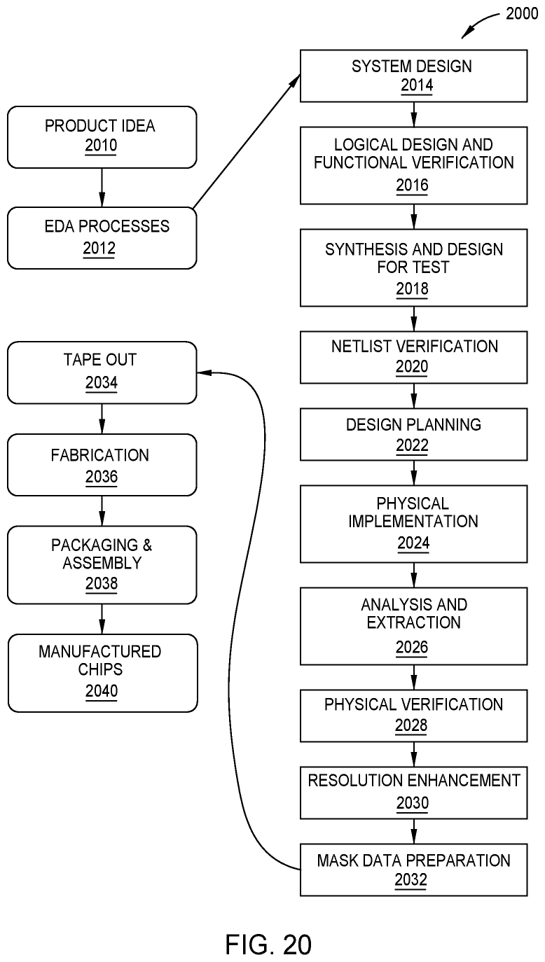

FIG. 19 illustrates a flowchart of a method 1900 for emulating a circuit design. The method 1900 is performed by the emulation environment 2100 of FIG. 21. In one example, the method 1900 is performed as part of EDA processes 2012 of FIG. 20. At 1910, a circuit design is received and control information is generated from the circuit design. For example, with reference to FIG. 21, the host system 2107 generates the control information form the circuit design. The control information defines the functions performed by each of the IC devices of the corresponding emulation system to emulate the circuit design.

At 1920, the circuit design is emulated based on the control information. For example, one or more of the emulation systems 100, 200, 600, 800, 1100, 1200, 1300, 1400, and 2102 are used to emulate the circuit design based on the control information. The control information is used to program the IC devices of the corresponding emulation system to perform the emulation process.

At 1930, a change in a voltage of a first signal associated with the circuit design is detected. For example, with reference to FIG. 1B, the detector circuitry 114 detects a change in a voltage of the signal 123. With reference to FIG. 2, the detector circuitry 214 detect a change in a voltage of the signal output from the logic elements 213. With reference to FIG. 6, the detector circuitry 616 detects a change in a voltage of the signal 613. With reference to FIG. 8, the detector circuitry 815 detects a change in a voltage of the signal 802, or the detector circuitry 818 detects a change in a voltage of the signal 805. With reference to FIG. 11, the detector circuitry 1115 detects a change in a voltage of the signal 127. With reference to FIGS. 12 and 13, the detector circuitry 1214 detects a change in a voltage of the signal 1242, and/or the detector circuitry 1233 detects a change in a voltage of the signal 1249. With reference to FIG. 14, the detector circuitry 1414 detects a change in a voltage of the signal 1453, the detector circuitry 1424 detects a change in a voltage of the signal 1458, and/or the detector circuitry 1434 detects a change in a voltage of the signal 1463. The signal that is analyzed by a detector circuitry may be output from the corresponding IC device, or internal to the IC device.

At 1940, the emulation process is stopped based on detecting the change in voltage of the first signal. For example, concentrator circuitry (e.g., the concentrator circuitry 115 of FIG. 1B or 11, the concentrator circuitry 215 of FIG. 2, the concentrator circuitry 618 of FIG. 6, the concentrator circuitry 817 of FIG. 8, the concentrator circuitry 1215 of FIG. 12 or 13, the concentrator circuitry 1234 of FIG. 12 or 13, or the concentrator circuitry 1415, 1425, or 1435 of FIG. 14) outputs a control signal indicating a stop to the emulation process based on detecting the change in the voltage of a signal by a corresponding detector circuitry. The emulation process is synchronized within each of the IC devices, such the emulation process is stopped at a common cycle of the emulation clock signal within each of the IC devices. A collector concentrator circuitry may receive the control signal and generate control signals that are communicated to each of the IC devices to stop the emulation process within each of the IC devices for one or more cycles of the emulation clock signal.

FIG. 19B illustrates a flowchart of a method 1950 for preparing a circuit design for emulation. The method 1900 is performed by the emulation environment 2100 of FIG. 21. In one example, the method 1900 is performed as part of EDA processes 2012 of FIG. 20.

At 1960, a circuit design is received. For example, with reference to FIG. 21, the host system 2107 receives the circuit design and maps the circuit design to one or more IC devices. In one example, the compiler 2110 of the host system 2107 maps the circuit design to one or more IC device. Mapping the circuit designs to one or more IC devices includes generating control information that defines the functions performed by each of the IC devices of the corresponding emulation system to emulate the circuit design.

At 1970, the circuit design is instrumented by inserting a change detection circuit and a synchronization circuit. For example, with reference to FIG. 21, the host system 2107, and/or the compiler 2110 of the host system 2107, inserts a change detection circuit (e.g., detector circuitry) and a synchronization circuit (e.g., concentrator circuitry) in an IC device. The change detection circuit detects a change in a signal (e.g., a change in voltage) and generates an output signal reflective of the change. The synchronization circuit is connected to the change detection circuit and stops emulation within an IC device for one or more emulation cycles based on the output signal of the change detection circuit. In one example, the change detection circuit is inserted such that the change detection circuit receives a MCP signal. An MCP signal is a signal output of by a circuit element driven with a clock signal (e.g., a local clock signal) having a frequency that is less than the frequency of the emulation clock signal). In one example, an MCP signal, or signals, are determined by the host system 2107, or the compiler 2110, based on the frequency of the local clock signals and the emulation clock signal to determine the location to insert the change detection circuit, and what signal, or signals, is to be routed to the change detection circuit. For example, with reference to FIG. 1B, the signal 123 is determined to a MCP signal as the signal 123 is derived from signal 121 and/or 122, which are output based on the clock signal 103. The clock signal 103 has a frequency that is less than the frequency of the corresponding emulation clock signal. Accordingly, the detector circuitry 114 (change detection circuit) is inserted such that the detector circuitry 114 receives the signal 123 and has an output connected to the concentrator circuitry 115 (e.g., synchronizer circuitry).

At 1980, the IC devices are provided for emulation. In one example, the IC devices are used by an emulation system (e.g., the emulation system 2102) to emulate the circuit design (e.g., DUT).

FIG. 20 illustrates an example set of processes 2000 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 2010 with information supplied by a designer, information which is transformed to create an article of manufacture that uses a set of EDA processes 2012. When the design is finalized, the design is taped-out 2034, which is when artwork (e.g., geometric patterns) for the integrated circuit is sent to a fabrication facility to manufacture the mask set, which is then used to manufacture the integrated circuit. After tape-out, a semiconductor die is fabricated 2036 and packaging and assembly processes 2038 are performed to produce the finished integrated circuit 2040.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 20. The processes described by be enabled by EDA products (or EDA systems).

During system design 2014, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 2016, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 2018, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 2020, the netlist is checked for compliance with timing constraints and for correspondence with the HDL code. During design planning 2022, an overall floor plan for the integrated circuit is constructed and analyzed for timing and top-level routing.

During layout or physical implementation 2024, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 2026, the circuit function is verified at the layout level, which permits refinement of the layout design. During physical verification 2028, the layout design is checked to ensure that manufacturing constraints are correct, such as DRC constraints, electrical constraints, lithographic constraints, and that circuitry function matches the HDL design specification. During resolution enhancement 2030, the geometry of the layout is transformed to improve how the circuit design is manufactured.

During tape-out, data is created to be used (after lithographic enhancements are applied if appropriate) for production of lithography masks. During mask data preparation 2032, the ‘tape-out’ data is used to produce lithography masks that are used to produce finished integrated circuits.

A storage subsystem of a computer system (such as computer system 2200 of FIG. 22, or host system 2107 of FIG. 21) may be used to store the programs and data structures that are used by some or all of the EDA products described herein, and products used for development of cells for the library and for physical and logical design that use the library.

FIG. 21 depicts a diagram of an example emulation environment 2100. An emulation environment 2100 may be configured to verify the functionality of the circuit design. The emulation environment 2100 may include a host system 2107 (e.g., a computer that is part of an EDA system) and an emulation system 2102 (e.g., a set of programmable devices such as Field Programmable Gate Arrays (FPGAs) or processors). The host system generates data and information by using a compiler 2110 to structure the emulation system to emulate a circuit design. A circuit design to be emulated is also referred to as a Design Under Test (‘DUT’) where data and information from the emulation are used to verify the functionality of the DUT.

The host system 2107 may include one or more processors. In the embodiment where the host system includes multiple processors, the functions described herein as being performed by the host system can be distributed among the multiple processors. The host system 2107 may include a compiler 2110 to transform specifications written in a description language that represents a DUT and to produce data (e.g., binary data) and information that is used to structure the emulation system 2102 to emulate the DUT. The compiler 2110 can transform, change, restructure, add new functions to, and/or control the timing of the DUT.

The host system 2107 and emulation system 2102 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 2102.11. The host system 2107 and emulation system 2102 can exchange data and information through a third device such as a network server.

The emulation system 2102 includes multiple FPGAs (or other modules) such as FPGAs 2104₁ and 2104₂ as well as additional FPGAs to 2104_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 2102 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 2104₁-2104_{N} may be placed onto one or more boards 2112₁ and 2112₂ as well as additional boards through 2112_{M}. Multiple boards can be placed into an emulation unit 2114₁. The boards within an emulation unit can be connected using the backplane of the emulation unit or any other types of connections. In addition, multiple emulation units (e.g., 2114₁ and 2114₂ through 2114_{K}) can be connected to each other by cables or any other means to form a multi-emulation unit system.

For a DUT that is to be emulated, the host system 2107 transmits one or more bit files to the emulation system 2102. The bit files may specify a description of the DUT and may further specify partitions of the DUT created by the host system 2107 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 2107 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 2107 and/or the compiler 2110 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 2105 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 22 illustrates an example machine of a computer system 2200 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 2200 includes a processing device 2202, a main memory 2204 (e.g., read-only memory (ROM), flash memory, dynamic random access memory (DRAM) such as synchronous DRAM (SDRAM), a static memory 2206 (e.g., flash memory, static random access memory (SRAM), etc.), and a data storage device 2218, which communicate with each other via a bus 2230.

Processing device 2202 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 2202 may also be one or more special-purpose processing devices such as an application specific integrated circuit (ASIC), a field programmable gate array (FPGA), a digital signal processor (DSP), network processor, or the like. The processing device 2202 may be configured to execute instructions 2226 for performing the operations and steps described herein.

The computer system 2200 may further include a network interface device 2208 to communicate over the network 2220. The computer system 2200 also may include a video display unit 2210 (e.g., a liquid crystal display (LCD) or a cathode ray tube (CRT)), an alphanumeric input device 2212 (e.g., a keyboard), a cursor control device 2214 (e.g., a mouse), a graphics processing unit 2222, a signal generation device 2216 (e.g., a speaker), graphics processing unit 2222, video processing unit 2228, and audio processing unit 2232.

The data storage device 2218 may include a machine-readable storage medium 2224 (also known as a non-transitory computer-readable medium) on which is stored one or more sets of instructions 2226 or software embodying any one or more of the methodologies or functions described herein. The instructions 2226 may also reside, completely or at least partially, within the main memory 2204 and/or within the processing device 2202 during execution thereof by the computer system 2200, the main memory 2204 and the processing device 2202 also constituting machine-readable storage media.

In some implementations, the instructions 2226 include instructions to implement functionality corresponding to the present disclosure. While the machine-readable storage medium 2224 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 2202 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving a circuit design, wherein the circuit design is mapped onto integrated circuit (IC) devices;
instrumenting the circuit design mapped onto the IC devices by inserting a first change detection circuit and a first synchronization circuit, the first synchronization circuit connected to the first change detection circuit and configured to stop emulation on one of the IC devices based on an output of the first change detection circuit and completion of a first one or more emulation cycles; and
providing the IC devices for emulation.

2. The method of claim 1, wherein the first change detection circuit and the first synchronization circuit are inserted in a first IC device of the IC devices.

3. The method of claim 2, wherein an input of the first change detection circuit is connected to a first circuit element configured to output a first signal based on a first clock signal having a frequency that is less than the frequency of an emulation clock signal.

4. The method of claim 3, wherein the first change detection circuit is configured to detect a change in the first signal, and output a change detection signal based on detecting the change in the first signal.

5. The method of claim 4, wherein the first one or more emulation cycles corresponds to a propagation time of the first signal from the first IC device of the IC devices to a second IC device of the IC devices.

6. The method of claim 2, wherein instrumenting the circuit design further comprises inserting a second change detection circuit and a second synchronization circuit in a second IC device of the IC devices, wherein the second synchronization circuit is connected to the first synchronization circuit.

7. The method of claim 6, wherein the second synchronization circuit is configured to stop emulation on the IC devices based on an output of the second change detection circuit and completion of a second one or more emulation cycles, the second one or more emulation cycles are subsequent to the first one or more emulation cycles.

8. The method of claim 2, wherein instrumenting the circuit design further comprises inserting a second change detection circuit in the first IC device, wherein the first synchronization circuit is connected to the second change detection circuit, and configured to stop emulation in the IC devices based on an output of the second change detection circuit.

9. The method of claim 8, wherein an input of the second change detection circuit is connected to a second circuit element configured to output a second signal based on a second clock signal having a frequency that is less than the frequency of an emulation clock signal, and wherein the second change detection circuit is configured to output a second change detection signal based on detecting a change in the second signal.

10. An emulation system comprising:
a host system that generates control information from a circuit design; and
a first integrated circuit (IC) device configured to emulate at least a portion of the circuit design based on the control information, the first IC device comprising:
first detector circuitry configured to detect a change in a first signal within the first IC device, and generate a first detector signal based on the detected change in the first signal; and
first concentrator circuitry configured to output a first control signal indicating a stop to an emulation process of the circuit design based on the first detector signal.

11. The emulation system of claim 10, wherein the first signal is output from the first IC device.

12. The emulation system of claim 11, wherein a second signal is generated from the first signal, and the second signal is output from the first IC device.

13. The emulation system of claim 11, wherein the first IC device further comprises:
second detector circuitry configured to detect a change in a second signal within the first IC device, and generate second first detector signal based on the detected change in the second signal, wherein the first concentrator circuitry is further configured to output the first control signal indicating a stop to the emulation process of the circuit design based on second detector signal.

14. The emulation system of claim 11 further comprising a second IC device, the second IC device comprising:
second detector circuitry configured to detect a change in a second signal within the second IC device, and generate a second detector signal based on the detected change in the second signal; and
second concentrator circuitry configured to output a second control signal indicating a stop to the emulation process based on second detector signal.

15. The emulation system of claim 14 further comprising a third IC device, the third IC device is connected between the first IC device and the second IC device, wherein the third IC device is configured to receive the first signal and generate a third signal, the second IC device receives the third signal and generates the second signal, and wherein a voltage change of the third signal is not detected within the third IC device.

16. The emulation system of claim 14, wherein the first control signal is configured to stop the emulation process for a first period associated with a propagation time of the first signal from the first IC device to the second IC device.

17. A method comprising:
receiving a circuit design and generating control information from the circuit design;
emulating, via an emulation process, the circuit design within integrated circuit (IC) devices of an emulation system based on the control information;
detecting a change in a voltage value of a first signal associated with the circuit design by a first IC device of the IC devices; and
stopping the emulation process of the circuit design within each of the IC devices for a period based on detecting the change in the voltage value of the first signal.

18. The method of claim 17, wherein the first signal is associated with a first timing path within the circuit design, and wherein the period is shorter than a propagation time of the first timing path.

19. The method of claim 17, wherein one of:
the first signal is output from the first IC device; or
a second signal is generated from the first signal, and the second signal is output from the first IC device.

20. The method of claim 19 further comprising:
detecting no change in voltage value of second signal by second IC device, wherein the first signal and the second signal are part of a first timing path; and
restarting the emulation process of the circuit design within each of the IC devices based on detecting no change in the voltage value of the second signal.
